(19) United States
(12) Patent Application Publication
(10) Pub. No.: US 2026/0116442 A1
(43) Pub. Date: Apr. 30, 2026

(54) STACKABLE UTILITY CART

(71) Applicants: Benjamin M. Wernberg, Savage, MN (US); Benjamin P. Williams, Chaska, MN (US); Joseph P. Foley, Mendota Heights, MN (US)

(72) Inventors: Benjamin M. Wernberg, Savage, MN (US); Benjamin P. Williams, Chaska, MN (US); Joseph P. Foley, Mendota Heights, MN (US)

(21) Appl. No.: 18/930,512

(22) Filed: Oct. 29, 2024

(51) Int. Cl. B62B 1/00; B62B 1/20; B62B 1/22; B62B 5/06

(52) U.S. Cl. CPC B62B 1/006; B62B 1/20; B62B 1/22; B62B 5/06

(57) ABSTRACT

A stackable utility cart with novel features is disclosed. The stacking cart allows for nesting of multiple carts to maximize density for storage and shipping, lowering the cost of storage and shipping, while minimizing parts and maximizing cart capacity. The stackable utility cart includes several improvements in function and ergonomics.

### TECHNICAL FIELD

The present disclosure relates generally to a utility cart that allows for nesting of carts to maximize density for storage and shipping, thus lowering the costs of storage and shipping.

### BACKGROUND

It is often desirable to transport cumbersome articles, using a cart or wagon, from point A to point B that could not otherwise be easily transported by one or more individuals. Furthermore, it is desirable to transport and easily dump various types of particulate matter, such as dirt, loose gravel, and livestock feed as well as a multitude of other articles.

There are many forms of carts that have been used for carrying and dumping a variety of items. Many of which contain a relatively flat bed used to contain the articles in transit and a pivoting mechanism for slidably removing the articles from the bed to an alternate location.

Dumping carts are known, including those disclosed in U.S. Pat. No. 3,833,263 to Jackson; U.S. Pat. No. 4,711,499 to Fortin; U.S. Pat. No. 4,889,390 to Campbell; U.S. Pat. No. 5,395,163 to Mandell et al; U.S. Pat. No. 5,544,944 to Keech; and U.S. Pat. No. 6,290,301 to Bockman, all of which are incorporated herein by reference. Improvements over these earlier patents include U.S. Pat. No. 6,662,679 to Hobdy et al; U.S. Pat. No. 6,851,756 to Pieschel; U.S. Pat. No. 6,962,370 to Simpson; U.S. Pat. No. 7,175,205 to Simpson; U.S. Pat. No. 7,210,697 to Simpson; U.S. Pat. No. 7,390,065 to Pieschel et al; U.S. Pat. No. 7,441,792 to Simpson; U.S. Pat. No. 7,818,865 to Pieschel et al; U.S. Pat. No. 7,887,141 to Pieschel et al; U.S. Pat. No. D819,917 to Simpson et al; U.S. Pat. No. D826,507 to Wemberg et al., all of which are incorporated herein by reference.

One solution offered to address the issue of a stackable cart is presented by U.S. Pat. No. 6,848,695 to Panasewicz et al, incorporated herein by reference. The yard cart of Panasewicz et al. addresses the ability to stack fully assembled yard carts. However, the yard cart of Panasewicz et al. has limited carrying volume in the transport position and the configuration of the yard cart requires significant reconfiguration between the transport, resting, and stacking positions. Additionally, while Panasewicz et al. addresses the ability to stack fully assembled carts, it does not address a configuration that maximizes shipping using standard shipping methods (standard 40-foot shipping containers typically have interior dimensions of 39′6″ long×7′6″ wide×7′10″ high).

Another solution that allows for stacking of carts to maximize the quantity of fully assembled carts is offered by U.S. Patent Publication US20220169296 to Wernberg et al., incorporated herein by reference. The stackable cart of Wernberg et al. has limited carry volume when in the transport position, has a narrower-than-optimal wheel spread, and, while improving the quantity of assembled carts that can be placed in a standard-sized shipping container, limits that quantity to 13 carts while having some stability issues while stacked.

### SUMMARY OF THE DISCLOSURE

The stackable utility cart of the present invention overcomes the deficiencies noted above. The disclosed and claimed concept provides for a cart that contains all its requisite parts while allowing for nesting of multiple carts to minimize the volume of the stacked carts. This stacking provides significant cost savings for transporting the carts and for storage of the carts while increasing the volume of carts themselves, increasing the stability of stacked carts, and improving features of existing stackable carts.

In one embodiment of the invention, a stackable utility cart includes a tub with wheels rotatably attachable to the tub. The tub and wheels are designed to allow the wheels to store within the inside of and at the base of the tub to maximize stacking quantity. The wheels are mountable to the tub via an axle that may be stored within the silhouette of the tub to facilitate stacking of the carts.

In another embodiment of the invention, the stackable utility cart includes a tub bottom that inclines from front to back to not only facilitate vertical stacking, but also providing improved balance of the cart when carrying a load and for improved ease of dumping a carried load.

A further embodiment of the invention includes improved ergonomics with increased horizontal distance between the handle and axle, optimized center of gravity when loaded, angle of back wall to prevent interference with the legs of a user while pulling or pushing the cart, and ability of the cart to stand upright for easier dumping.

Another embodiment of the invention incorporates coplanar surfaces on the bottoms of the axle mounts and feet of the cart to allow cart tub to rest flat on the ground or within a pallet for shipping of carts or for storage and display of carts at retail facilities or warehouses.

An additional embodiment of the invention incorporates an improved pallet to be used for shipping the stackable cart of the invention that promotes stability of a complete stack of nested carts while fitting within the footprint of the cart while adding negligible height to a pallet of stacked carts. The design of the cart and pallet allows for simple strapping to further improve the stability of stacked carts for shipment or storage while adding minimal weight and waste material.

Yet another embodiment includes drain hole for the tub that also allows the wheels of the cart to be attached to the cart via strapping combined with a disposable packing disk for shipping that can be plugged with a plug that is storable on the handle of the cart to prevent loss.

A further embodiment of the invention includes ribbing that not only increases the strength of the upper lip of the cart, but also minimizes slack between the stacked carts to improve shipping and storage stability of stacked carts.

From the foregoing disclosure and the following more detailed description of various preferred embodiments it will be apparent to those skilled in the art that the present invention provides a significant advance in the technology and art of carts. Particularly significant in this regard is the potential the invention affords for providing a high quality, reliable, low-cost stackable assembly of utility carts. Additional features and advantages of various preferred embodiments will be better understood in view of the detailed description provided below.

The summary above is not intended to describe each illustrated embodiment or every implementation of the present disclosure. The figures and the detailed description that follow more particularly exemplify these embodiments.

### BRIEF DESCRIPTION OF THE DRAWINGS

The disclosure can be more completely understood in consideration of the following detailed description of various embodiments of the disclosure, in connection with the accompanying drawings, in which:

FIG. 1 is a perspective view of a stackable utility cart in an assembled configuration in accordance with an embodiment of the disclosure.

FIG. 2 is a front elevation view of the assembled stackable utility cart of FIG. 1.

FIG. 3 is a rear elevation view of the assembled stackable utility cart of FIG. 1.

FIG. 4 is a right-side elevation view of the assembled stackable utility cart of FIG. 1.

FIG. 5 is a left side elevation view of the assembled stackable utility cart of FIG. 1.

FIG. 6 is a top plan view of the assembled stackable utility cart of FIG. 1.

FIG. 7 is a bottom plan view of the assembled stackable utility cart of FIG. 1.

FIG. 8 is a perspective view of the stackable utility cart of FIG. 1 in an unassembled configuration.

FIG. 9 is a front elevation view of the unassembled stackable utility cart of FIG. 8.

FIG. 10 is a rear elevation view of the unassembled stackable utility cart of FIG. 8.

FIG. 11 is a right-side elevation view of the unassembled stackable utility cart of FIG. 8.

FIG. 12 is a left side elevation view of the unassembled stackable utility cart of FIG. 8.

FIG. 13 is a top plan view of the unassembled stackable utility cart of FIG. 8.

FIG. 14 is a bottom plan view of the unassembled stackable utility cart of FIG. 8.

FIG. 15 is a cross-sectional view taken along the line A-A in FIG. 13.

FIG. 15A is a close-up left side elevation view of the front tire and wheel strap of FIG. 13.

FIG. 16 is a cross-sectional view taken along line B-B in FIG. 13.

FIG. 17 is a close-up view of the area within the arc C-C in FIG. 13.

FIG. 17A is a perspective view of the tire of FIG. 17.

FIG. 17B is a close-up view of the tire of FIG. 17.

FIG. 18 is a perspective view of a stack of 24 unassembled stackable utility carts of FIG. 8 on a pallet for shipping or storage in accordance with another embodiment of the disclosure.

FIG. 19 is a front elevation view of the stack of 24 unassembled stackable utility carts of FIG. 18.

FIG. 20 is a rear elevation view of the stack of 24 unassembled stackable utility carts of FIG. 18.

FIG. 21 is a right-side elevation view of the stack of 24 unassembled stackable utility carts of FIG. 18.

FIG. 22 is a left side elevation view of the stack of 24 unassembled stackable utility carts of FIG. 18.

FIG. 23 is a top plan view of the stack of 24 unassembled stackable utility carts of FIG. 18.

FIG. 24 is a bottom plan view of the stack of 24 unassembled stackable utility carts of FIG. 18.

FIG. 25 is a front elevation view of a sub stack of six unassembled stackable utility carts for shipping or storage in accordance with another embodiment of the disclosure.

FIG. 26 is a left side elevation view of the sub stack of six unassembled stackable utility carts of FIG. 25.

FIG. 27 is a cross-sectional view taken along the line D-D in FIG. 25.

FIG. 28 is a cross-sectional view taken along the line E-E in FIG. 26.

FIG. 29 is a close-up cross-sectional view of the area within the arc F-F in FIG. 27.

FIG. 30 is a perspective view of a stackable utility cart in an assembled configuration in accordance with another embodiment of the disclosure.

FIG. 31 is a front elevation view of the assembled stackable utility cart of FIG. 30.

FIG. 32 is a rear elevation view of the assembled stackable utility cart of FIG. 30 with a cut-out showing the drain orifice, drain plug, and shipping packing disk.

FIG. 33 is a right-side elevation view of the assembled stackable utility cart of FIG. 30.

FIG. 34 is a left side elevation view of the assembled stackable utility cart of FIG. 30.

FIG. 35 is a top plan view of the assembled stackable utility cart of FIG. 30.

FIG. 36 is a bottom plan view of the assembled stackable utility cart of FIG. 30.

FIG. 37 perspective view of a pallet in accordance with another embodiment of the disclosure.

FIG. 38 is a front elevation view of the pallet of FIG. 37.

FIG. 39 is a rear elevation view of the pallet of FIG. 37.

FIG. 40 is a right-side elevation view of the pallet of FIG. 37.

FIG. 41 is a left side elevation view of the pallet of FIG. 37.

FIG. 42 is a top plan view of the pallet of FIG. 37.

FIG. 43 is a bottom plan view of the pallet of FIG. 37.

FIG. 44 is a right-side elevation view of a pallet and cart with shipping straps in accordance with an embodiment of the invention.

FIG. 45 is a rear elevation view of the pallet, cart, and shipping straps of FIG. 44.

FIG. 46 is a front elevation view of the pallet, cart, and shipping straps of FIG. 44.

FIG. 47 is a cross-sectional view taken along the line G-G in FIG. 44.

FIG. 48 is a cross-sectional view taken along the line H-H in FIG. 44.

While embodiments of the disclosure are amenable to various modifications and alternative forms, specifics thereof shown by way of example in the drawings will be described in detail. It should be understood, however, that the intention is not to limit the disclosure to the particular embodiments described. On the contrary, the intention is to cover all modifications, equivalents, and alternatives falling within the spirit and scope of the subject matter as defined by the claims.

### DETAILED DESCRIPTION

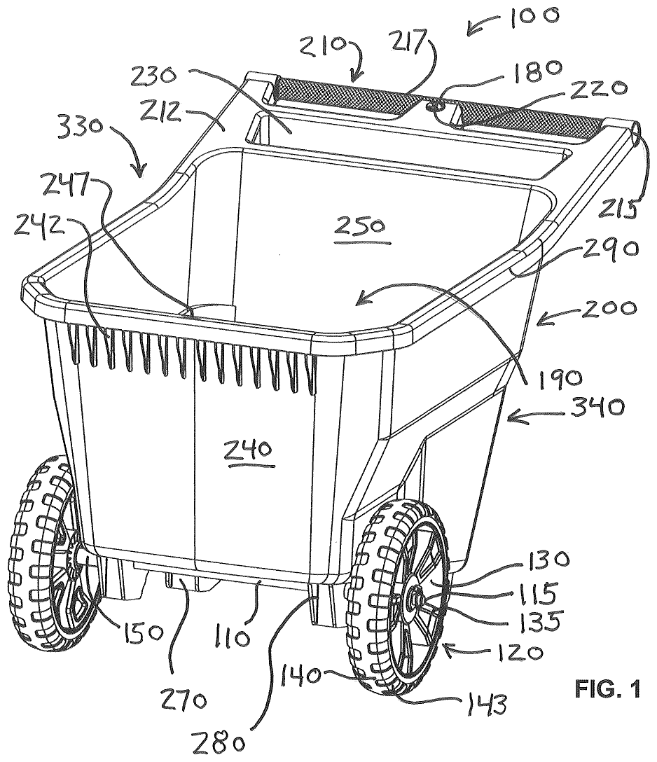

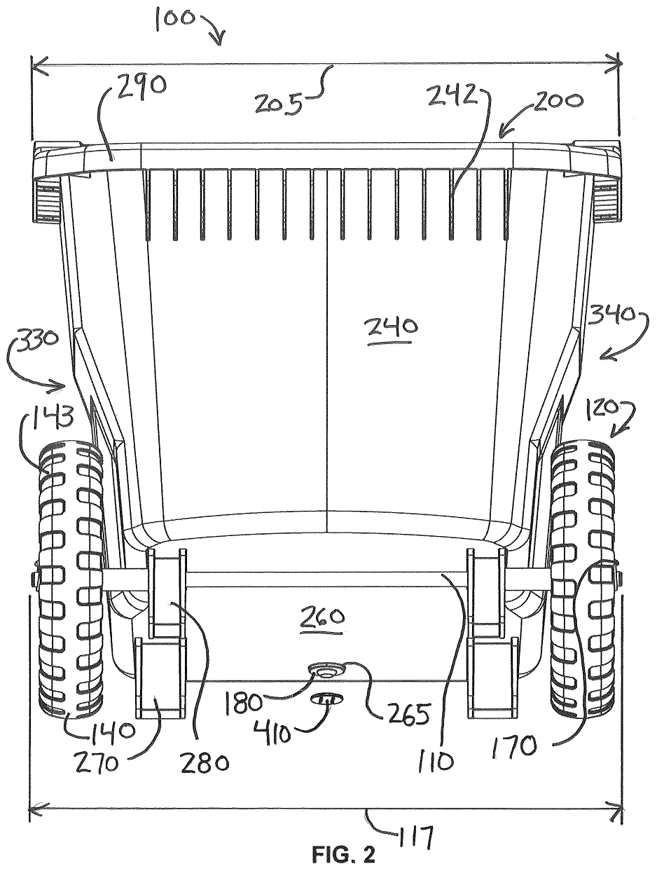

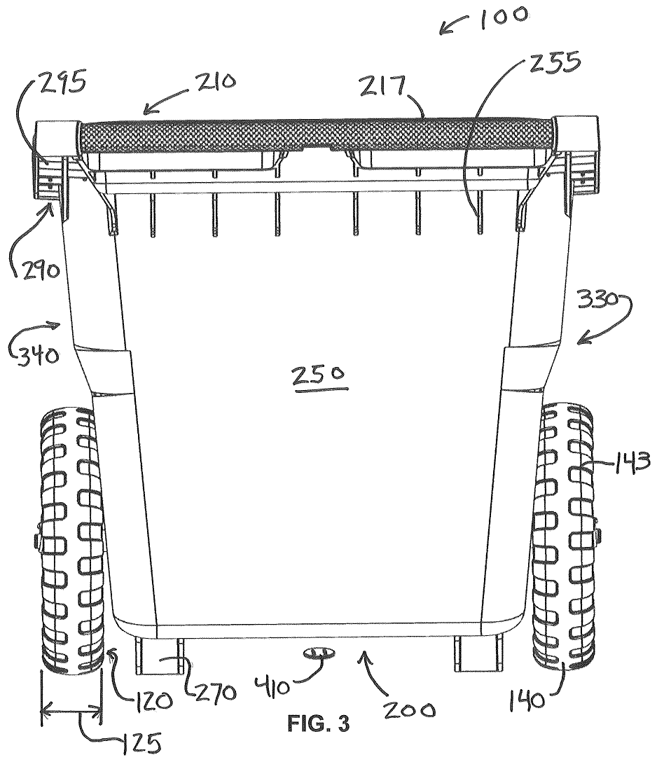

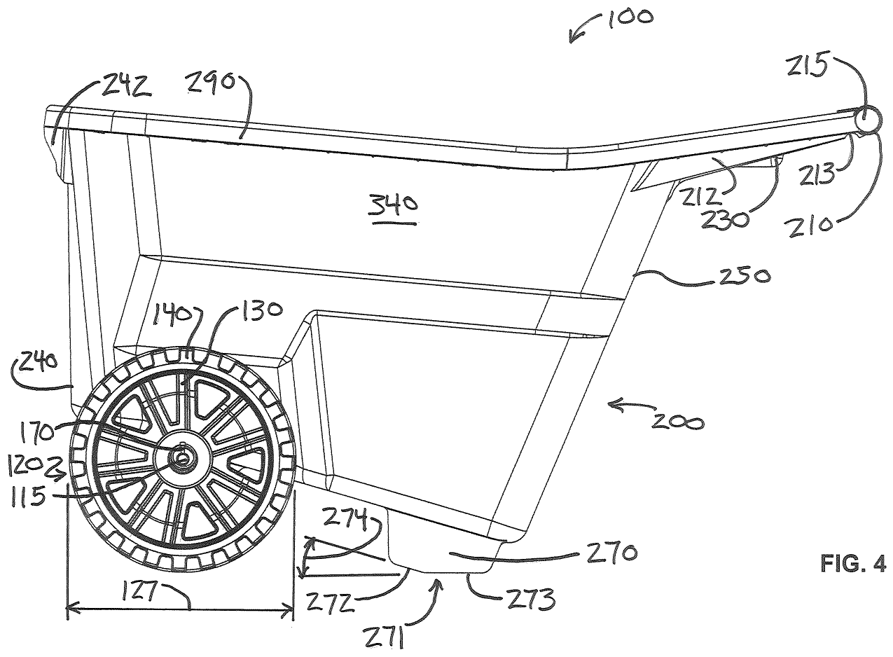

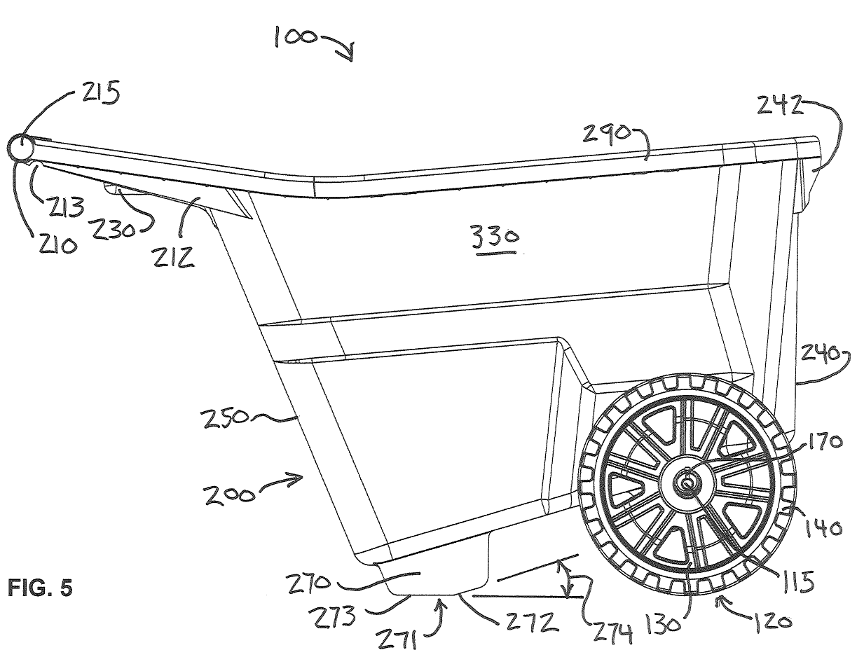

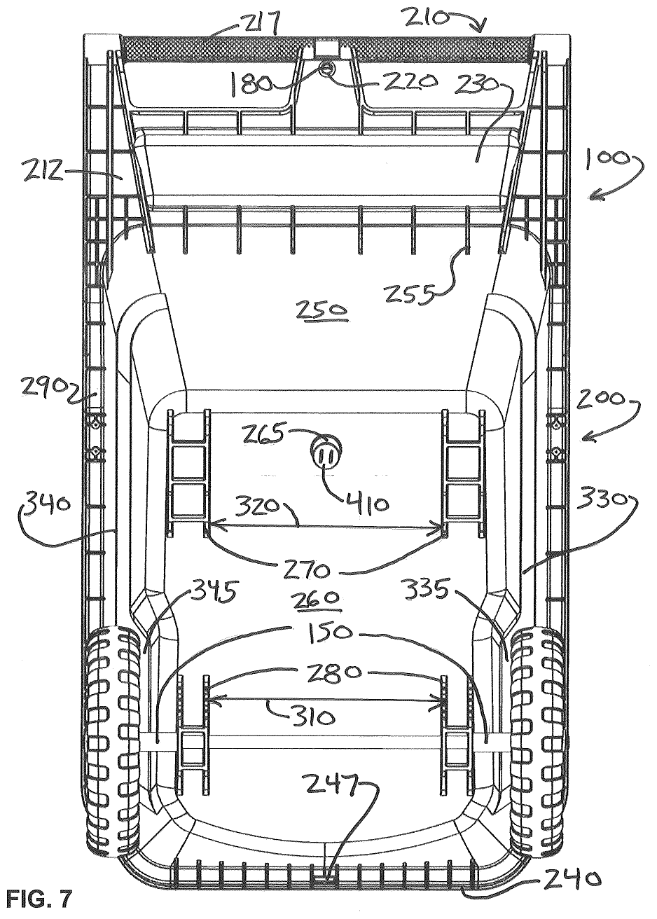

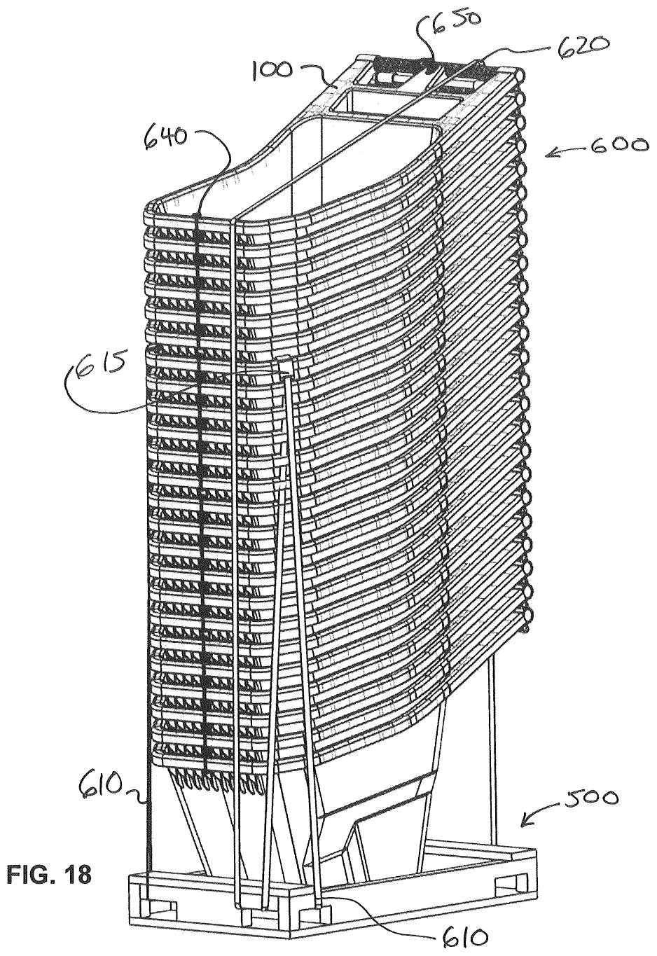

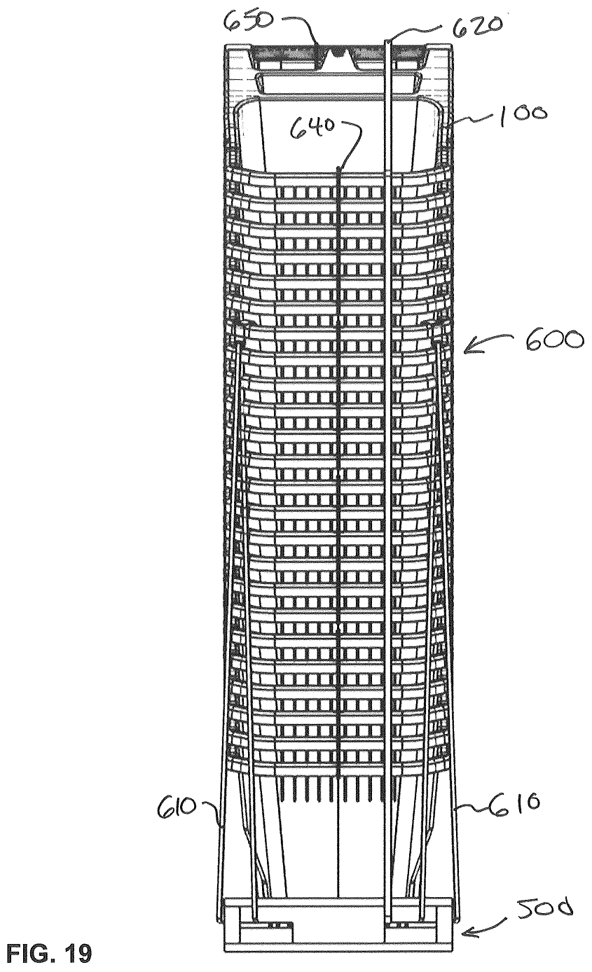

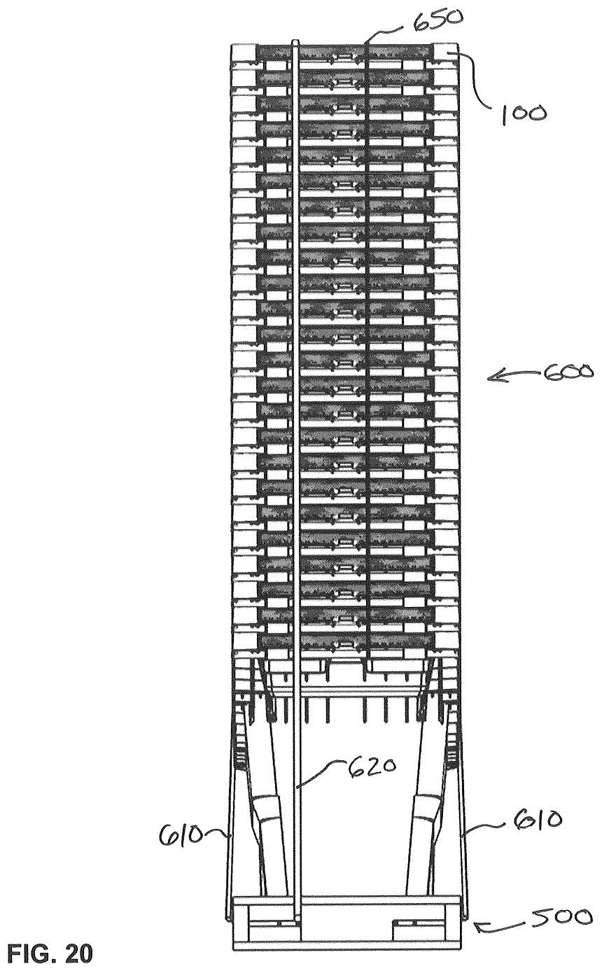

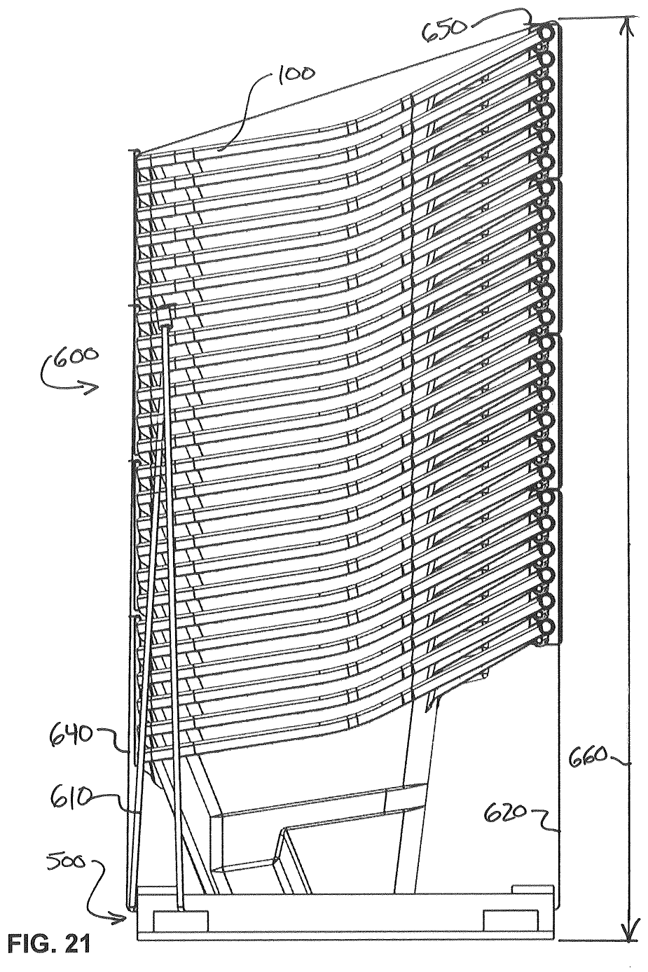

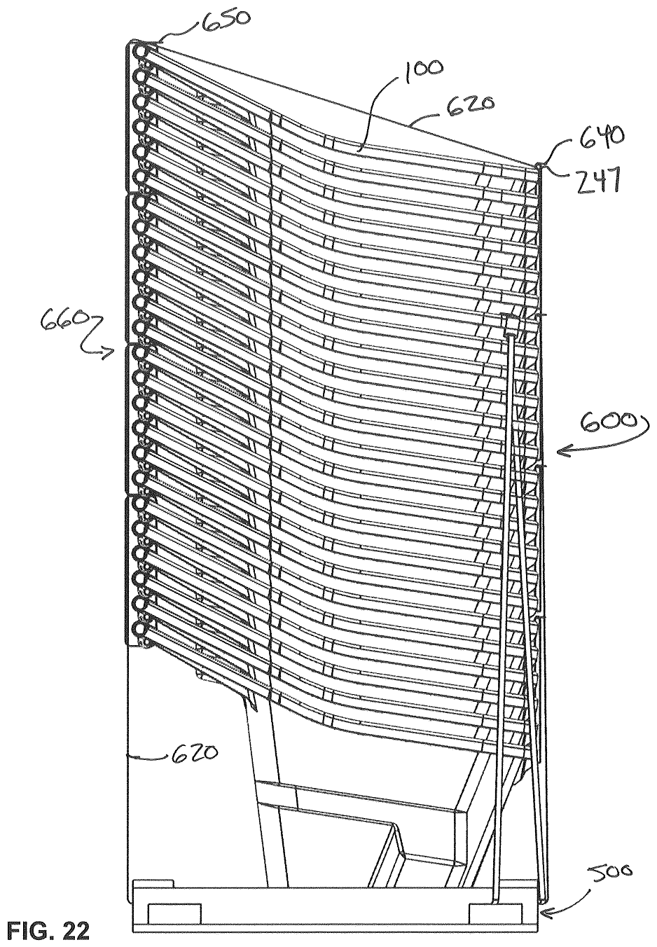

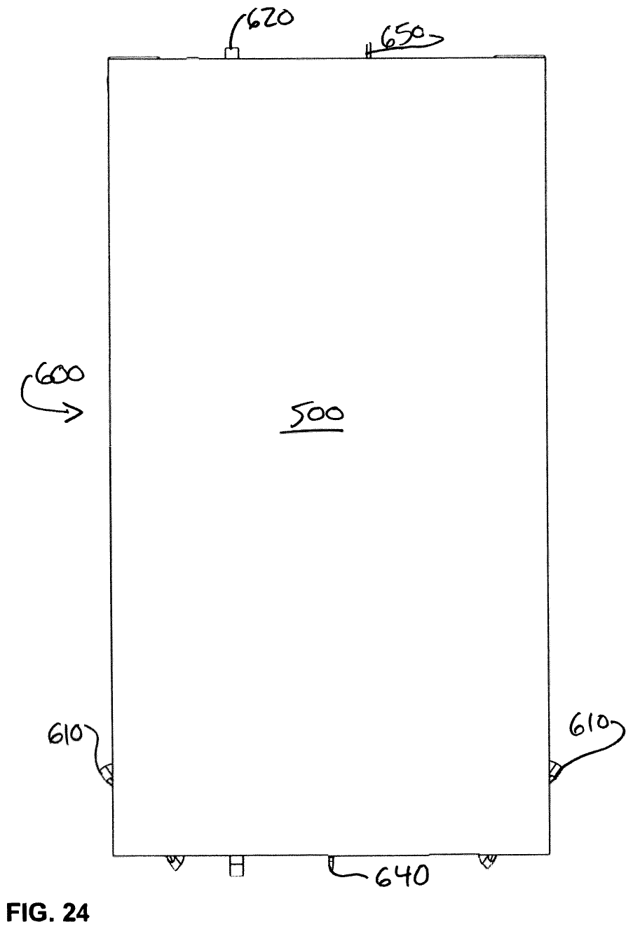

Referring to FIGS. 1-7, a stackable utility cart 100 is depicted in accordance with an embodiment of the disclosure. The stackable utility cart 100 is configured to allow the stackable cart 100 to be nested within another stackable cart 100 such as shown in FIGS. 18-24.

A significant advantage of the present stackable utility cart 100 over prior art carts is the ability to stack the carts in a vertical manner by nesting a stackable cart 100 within a second stackable cart and then nesting those stackable carts 100 within another stackable cart. As seen in FIG. 18, the optimal arrangement minimizes the volume of multiple stackable carts 100 to lessen the cost of transport and storage of the stackable cart 100. The arrangement allows for 24 stackable utility carts 100 to be nested in a shipping stack 600 to have a height 660 that fits within the interior height of a standard 40-foot HQ (High Cube) shipping container (8′10″).

The stackable utility cart tub 200 has a width 205 and length 206 such that two rows of 18 stacks 600 of 24 stackable carts 100 can fit within the interior of a standard 40-foot HQ shipping container. FIG. 49 provides the arrangement of shipping stacks 600 that will allow 864 stackable utility carts to fit within a standard shipping container with a width not to exceed 8′6″ and a length not to exceed 39′6″.

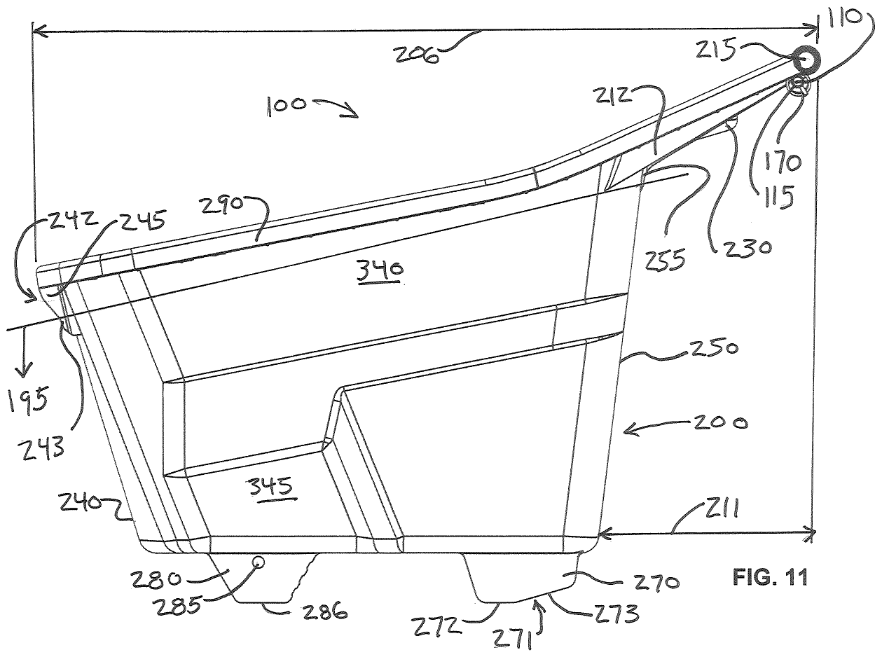

The interior volume 190 of the tub 200 of the stackable utility cart 100 is dimensionally sized to accept the cart tub lower portion 195 of a second stackable utility cart 100 nested within it. The cart tub lower portion 195 of the stackable cart 100 is defined as the portion of stackable cart tub 200 below front wall rib outer step 245 and rear wall rib 255 (see FIGS. 11 & 29).

The stackable cart 100 includes a tub 200, a plurality of wheels 120, and an axle 110. The axle 110 can be manufactured with any materials and methods known in the art. Preferably the axle 110 is a steel tube, can be solid or any material with suitable strength and durability. The tub 200 includes a front wall 240, rear wall 250, bottom 260, right wall 330, left wall 340, and lip 290. The tub 200 further includes a handle 210, one or more legs 270, and one or more axle supports 280. The tub 200, wheels 120, legs 270, and axle supports 280 are dimensioned to allow the lip 290 to be generally parallel to a surface upon which the cart 100 rests. The tub 200, legs 270, and axle supports 280 are dimensioned so that when the wheels 120 are not installed, the bottom 260 is parallel to the surface upon which the cart 100 rests (e.g., see FIG. 11). The legs 270 and axle supports 280 may be solid, enclosed yet partially hollow, or as shown in the drawings, molded with walls and spaces to decrease the weight of the cart 100 while still meeting structural requirements. This design allows for optimum load handling when the cart 100 is in use and allows unassembled carts 100 to be stacked for efficient shipping and storage (e.g., see FIG. 18). Furthermore, the legs 270 and axle supports 280 are preferably molded as part of the unibody tub 200 (as are other parts such as the handle 210, tray 230, and other parts) or can be molded separately and attached to the tub 200 by any means known in the art (welding, screws, adhesive, etc.).

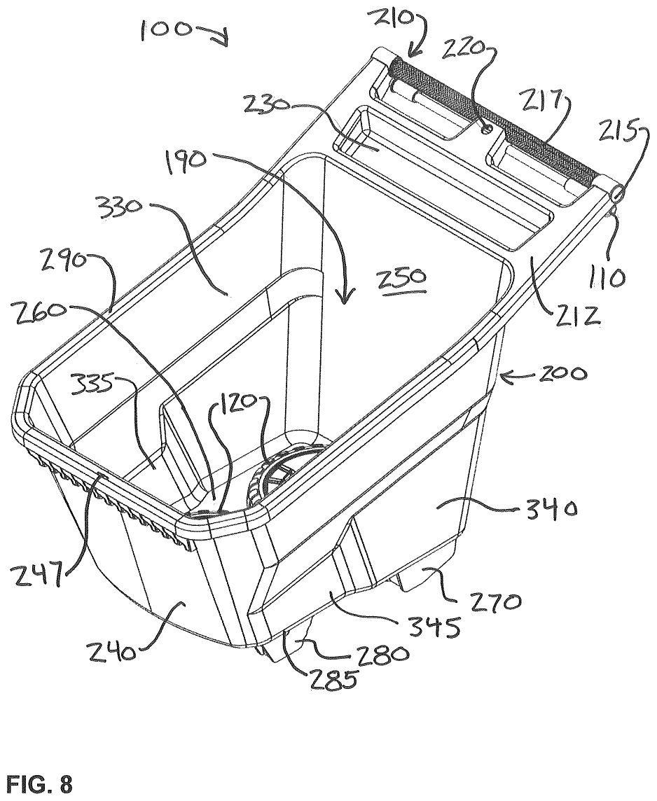

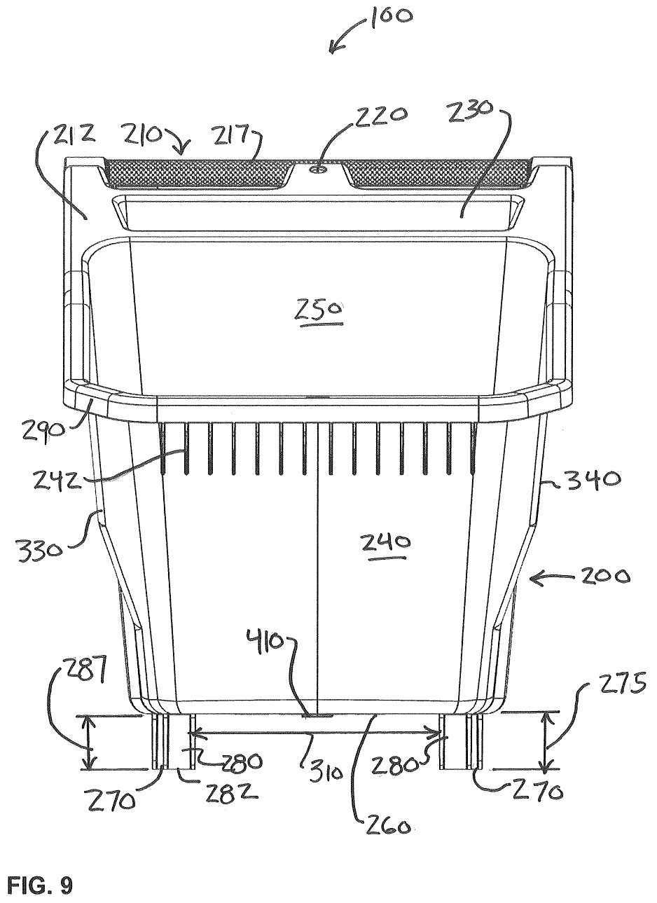

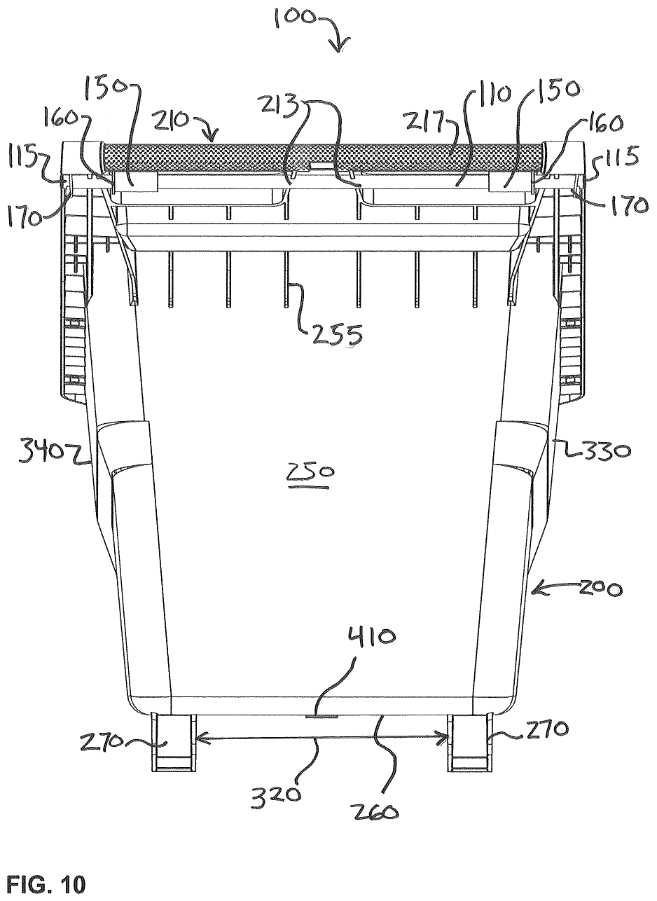

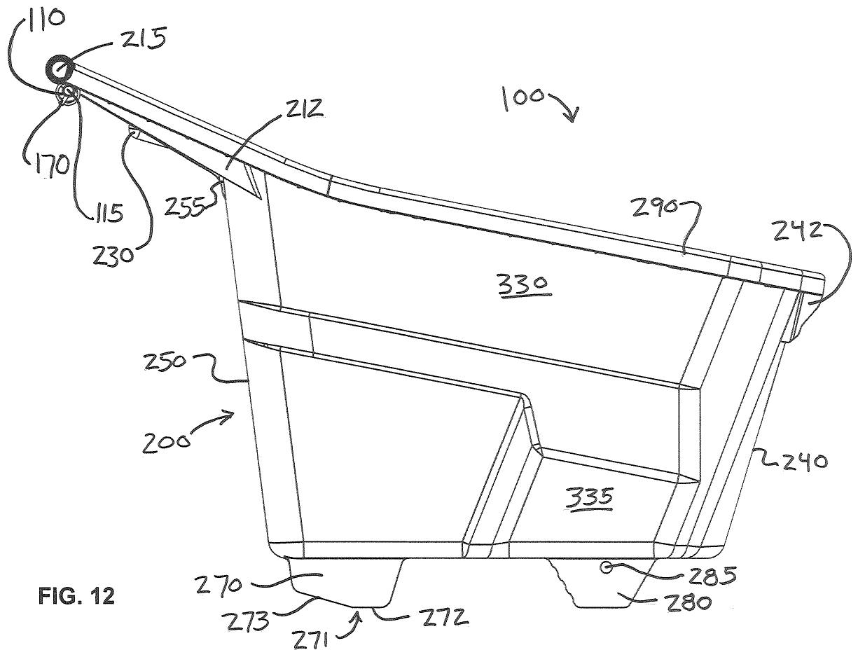

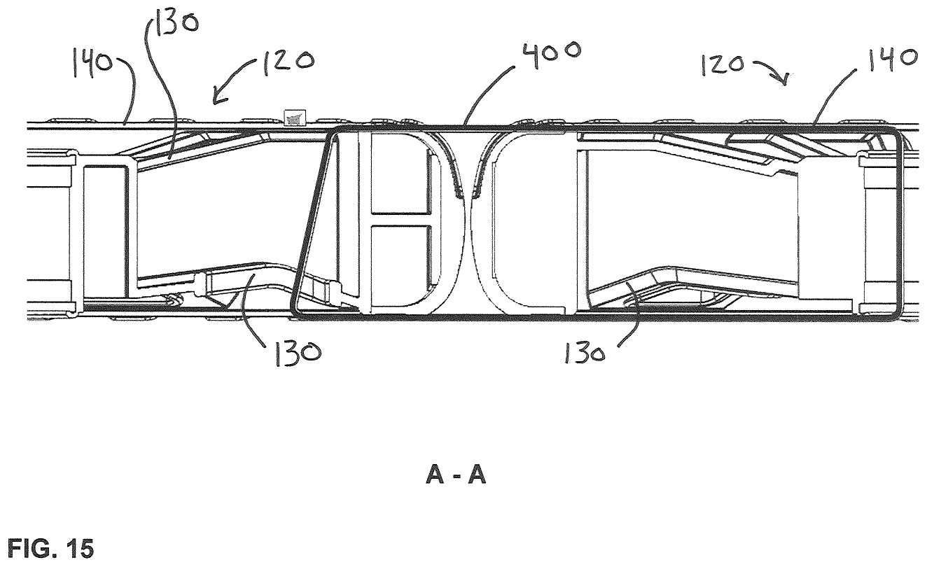

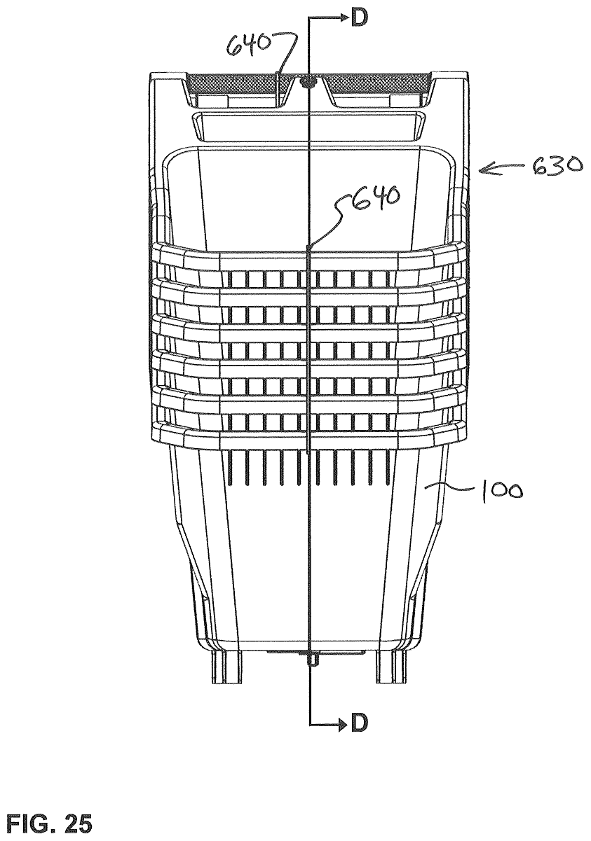

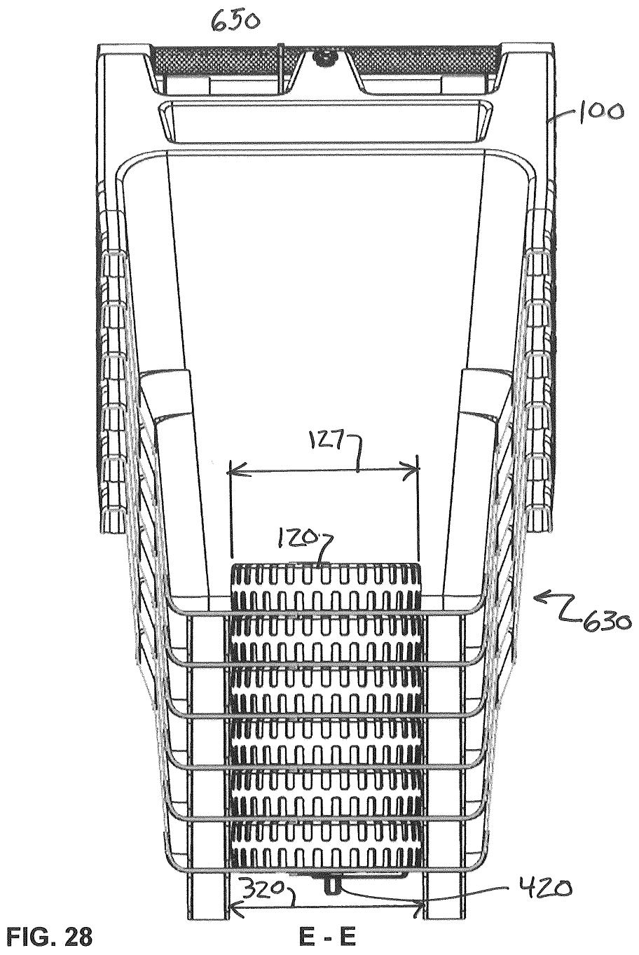

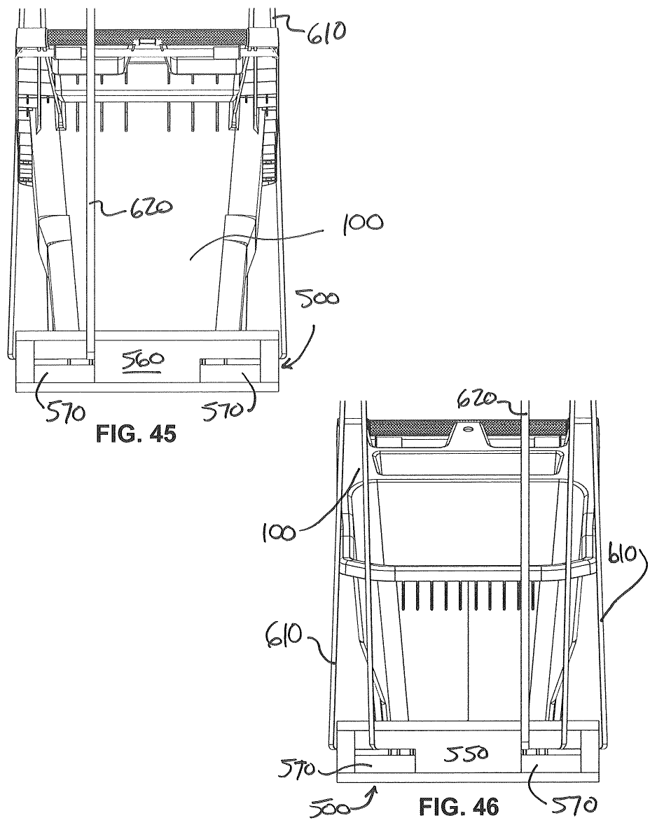

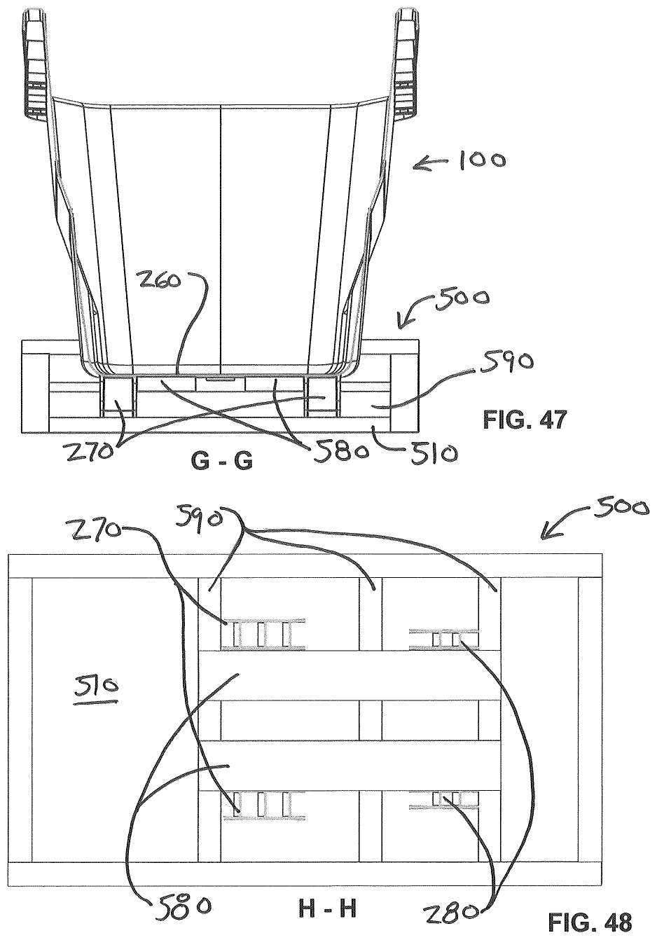

The tub 200 also preferably includes a tray 230 for storage of tools or other paraphernalia and is preferably between the handle 210 and rear wall 250 to allow ease of access. It is desirable that the tray 230 be as deep as possible without interfering with the ability to stack the utility cart 100 to maximize volume. The handle 210 preferably includes a texture 217 to provide better grip and handle caps 215 at each end of the handle 210 to prevent foreign material from entering the handle 210 and to provide a finished appearance. Tub 200 may also include a drain orifice 265 that is optimally located at the lowest part of the tub 200 to allow liquids to be drained from the cart 100 or for the cart 100 to be washed without having to tip it over to drain. To prevent material from inadvertently draining from the tub 200, cart 100 includes a removable drain plug 180. The drain plug 180 may be stored in a plug storage cavity 220 located anywhere on tub 200, but preferably located near the handle 210 for ease of access and to see if it is installed. The plug storage cavity 220 is also used to store the drain plug 180 when the cart 100 is in its shipping or storage configuration (FIGS. 8-29 and 44-48).

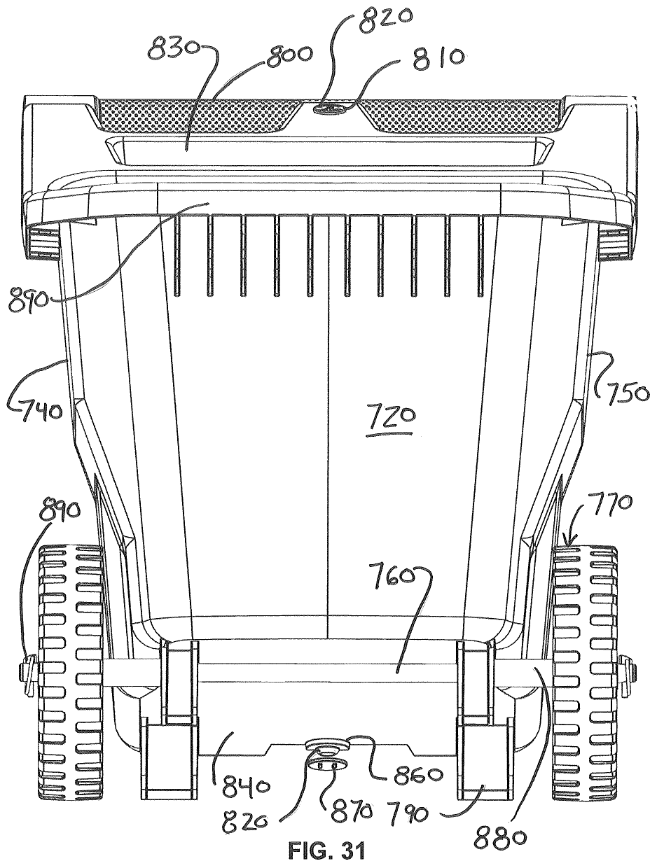

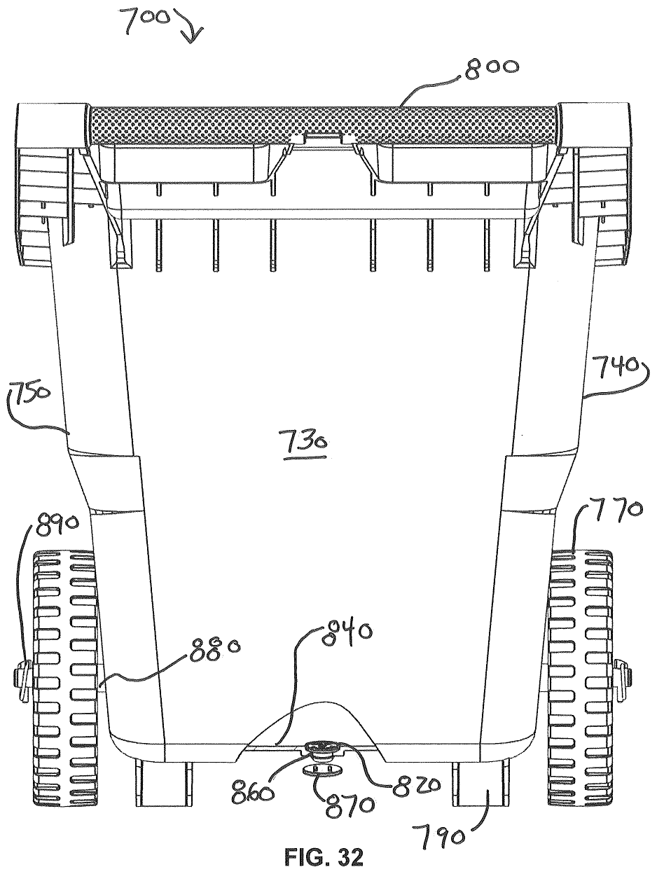

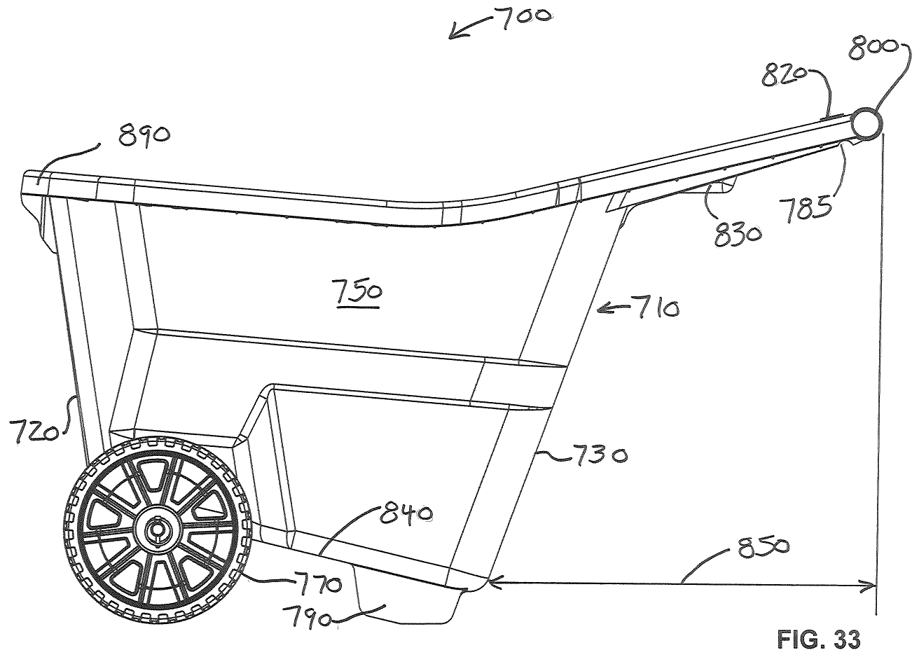

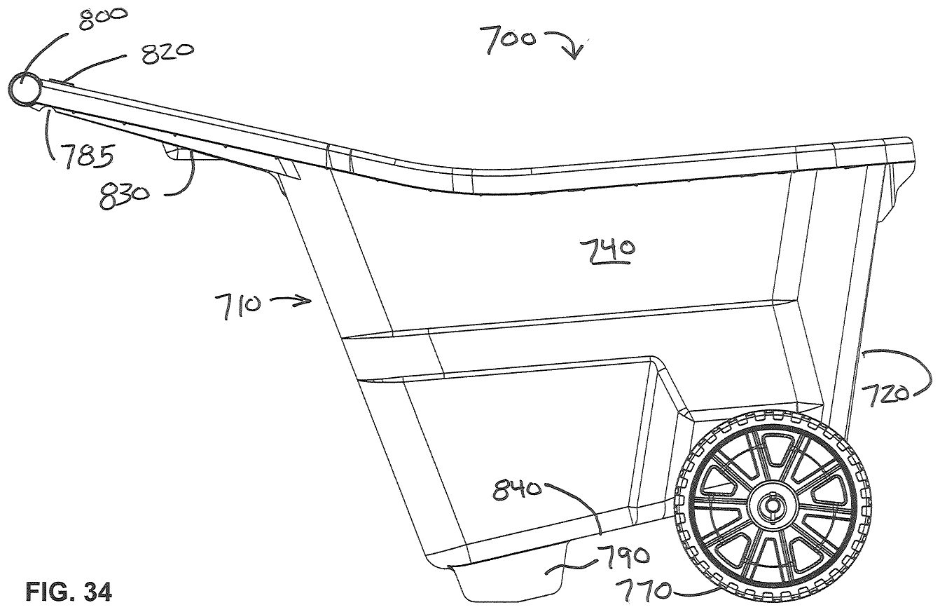

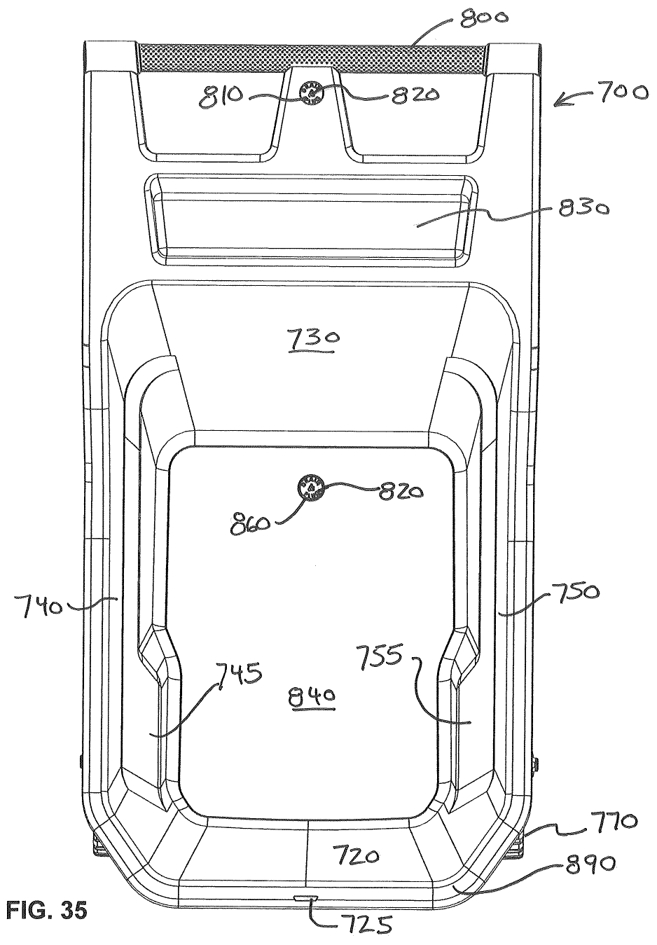

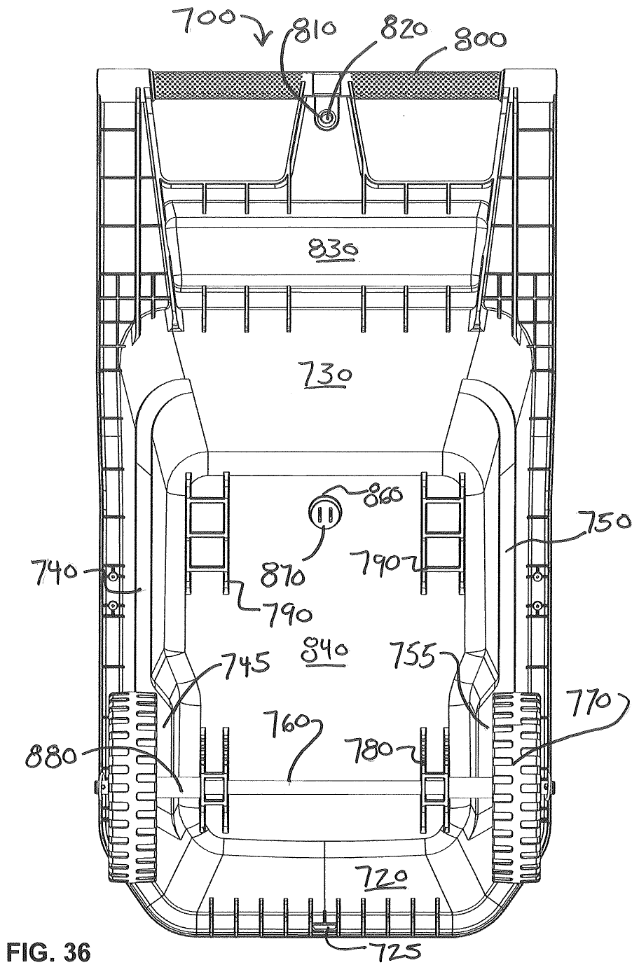

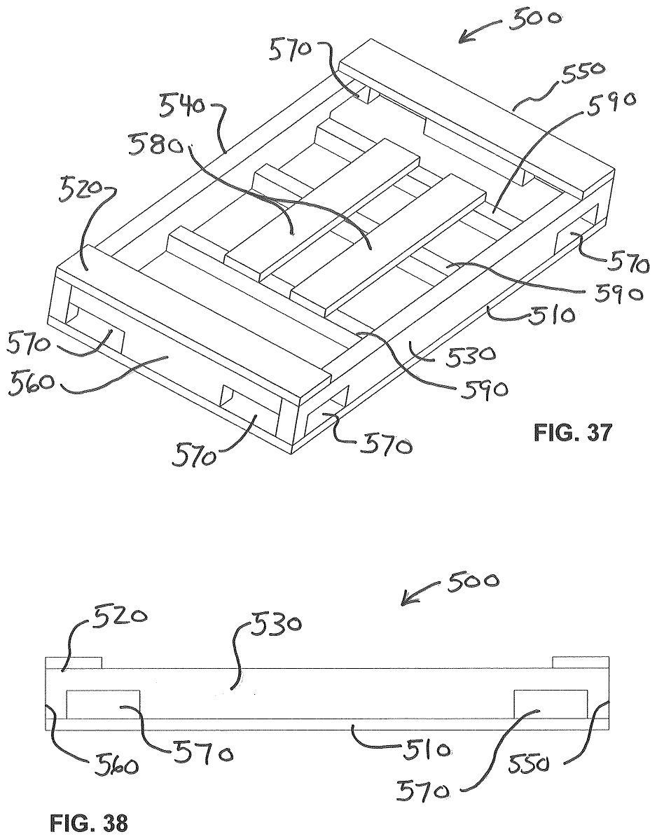

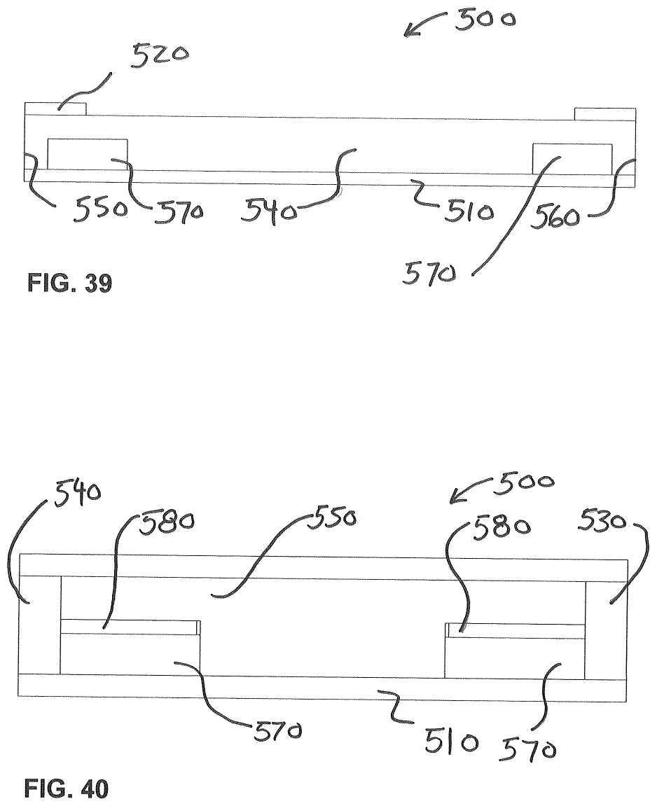

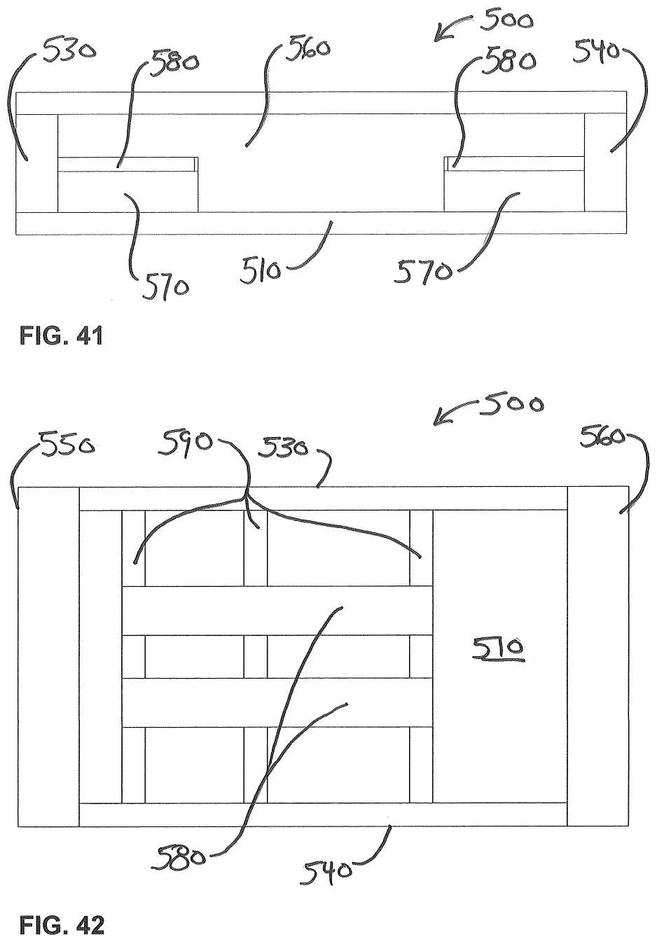

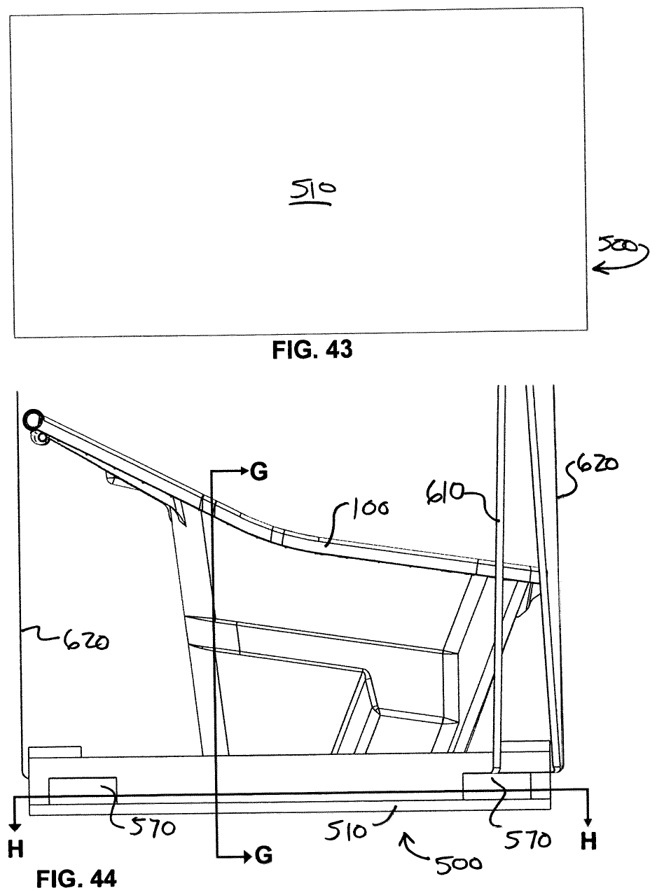

A benefit of the design of the current invention is the bottom 260 of the assembled cart 100 (FIGS. 1-7 and 30-36 for alternate embodiment) slopes from the front wall 240 toward the rear wall 250. This arrangement allows for the center of gravity for a carried load to be located lower and more toward the rear wall 250 than prior art carts (with bottoms that are generally level to the surface on which the cart rests). This design makes the cart 100 easier to move and maneuver compared to prior art carts as well as increases the load necessary on the handle 210 to tip the cart 100 backwards.

Another ergonomic improvement of the present invention is the distance between the handle 210 and the rear wall 250 of the cart. This distance, the handle offset 211 (see FIG. 11), is an improvement over existing carts because it allows almost any user to push or pull the cart 100 without the user's foot kicking or being restricted by the tub 200. Preferably this offset is at least 20 inches. This improved handle offset 211 also provides a longer moment arm for lifting a carried load. This design also functions with the weight distribution of a carried load to require less forward force to lift a given load, thus reducing the cart 100 from “running away” while a user is moving the cart 100 forward.

Yet another ergonomic improvement of the present invention are the angles of the tub front wall 240 and the tub bottom 260. Prior art utility carts with flat tub bottoms have bottoms that slope from the rear of the cart toward the front of the cart. This design places the center of gravity for a carried load toward the front of the cart, thus resulting in the aforementioned “running away” of the cart once moving forward. Another problem with the prior art cart design is that dumping of a carried load can result in an uncontrolled flipping of the entire cart. The design of the present invention prevents this situation by having a tub front wall 240 that will rest on the ground along with the wheels 120 while the tub bottom 260 is in a near-vertical position but will still be angled back toward the user.

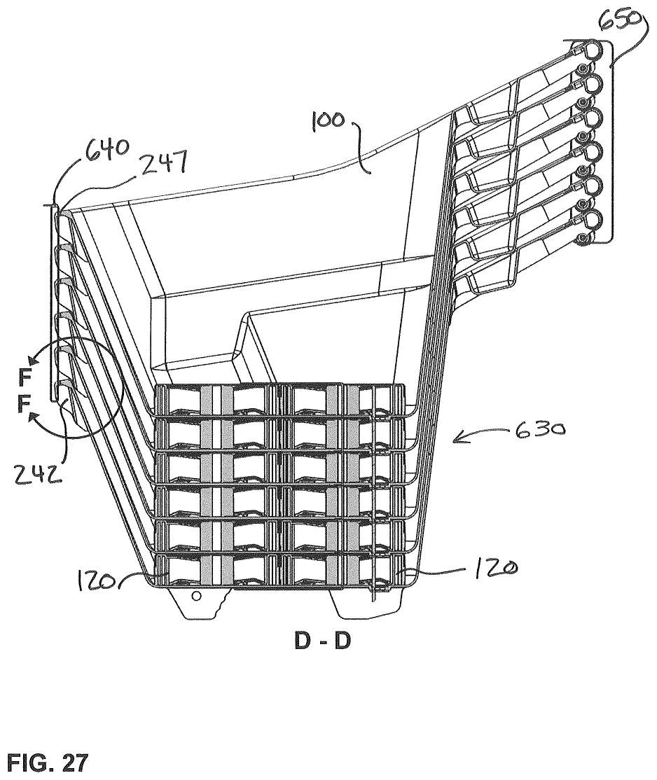

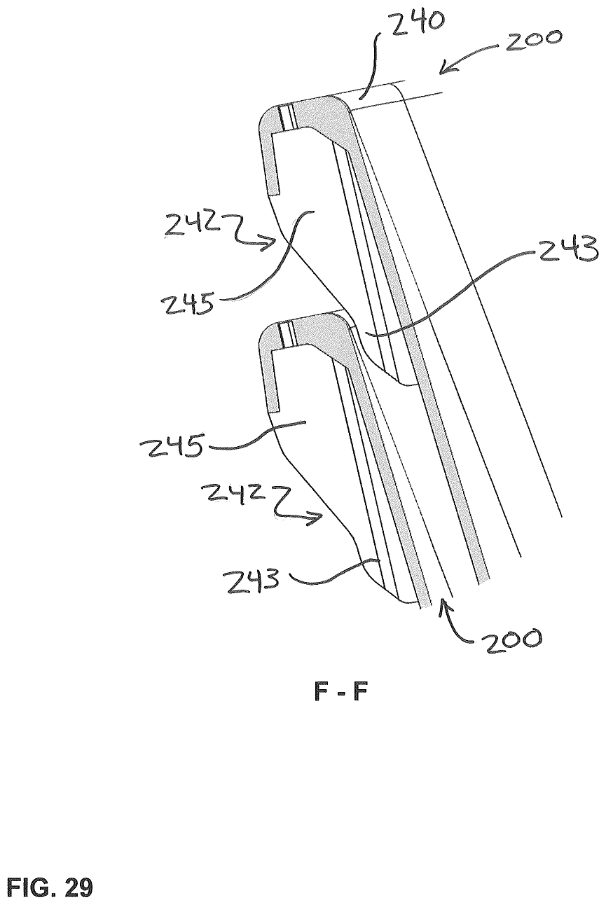

A further improvement of the present invention over prior art utility carts is in the design and use of ribs in the walls 240, 250, 330, 340 and lip 290 of the tub 200 to eliminate slack between stacked carts 100, thus making shipping and storage of multiple carts 100. The cart tub 200 utilizes front wall ribs 242 that connect the front wall 240 to the lip 290 on the front wall 240. These ribs 242 can be separately manufactured and latter attached to the tub 200 by adhesive or other means known in the art. The primary purpose of the front wall ribs 242 is to provide strength to the top of the front wall 240 and lip 290. However, the front wall ribs 242 (as are other ribs such as the rear wall ribs 255) are preferably molded into the tub 200 to form a single structure. As illustrated in FIG. 29, the front wall ribs 242 comprise a rib inner step 243 and a rib outer step 245. When cart tubs 200 are stacked as shown in FIG. 27, the inner step 243 of the upper cart tub 200 abuts the upper front wall 240 of the lower cart. This arrangement eliminates slack between the cart tubs 200 to prevent movement and shifting of the carts 100 during shipping. The outer step 245, being larger, provides more strength to the lip 290 of the wall. This two-tier rib 242 thus provided requisite strength to the lip 290 while allowing stacked carts 100 to better nestle. Similarly, the present invention contemplates use of rear wall ribs 255 to provide both strength to the rear wall lip 290 as well as prevent slack between nested tubs 200. Strength is also provided to the lips 290 of the right and left side walls 330, 340 with lip ribs 295. While the design illustrated in the drawings utilize lip ribs 255 that do not extend beyond the lips of the right and left side walls 330, 340, the present invention also contemplates lip ribs 255 extending beyond the lips of the right and left side walls 330, 340.

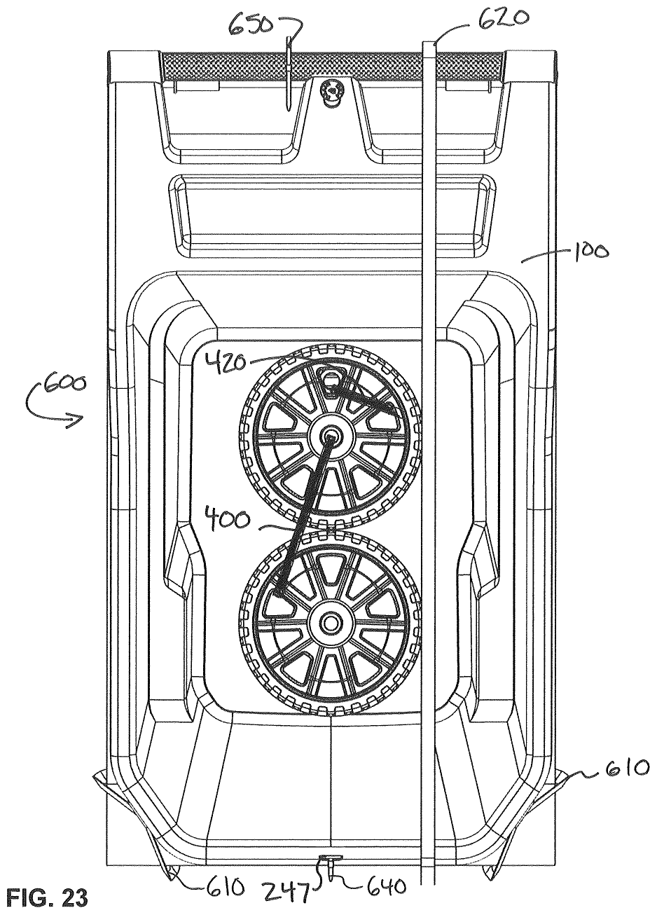

To provide stability during shipping or storage, the present invention also contemplates use of one or more front shipping straps 610 and total stack shipping strap 620 that are used to tie the shipping stack 600 to a shipping pallet 500. The front and rear shipping straps 610, 620 are preferably glass-reinforced plastic belt binds, but can be any material known in the art for securing product for storage or shipping. It is a preferred embodiment that each shipping stack 600 be comprised of four sub stacks 630 of six carts 110 each that are separately strapped together using the same type of shipping straps 610, 620 as for the entire shipping stack 600. To further secure the carts 100 for shipping or storage, the sub stacks 630 are strapped together with a front sub stack strap 640 that passes through a strap slot in the front lip 290 of each cart (see FIG. 23). There is also a rear sub stack strap 650 that preferably passes around the handles 210 of each cart 100 in a sub stack 630 to secure the rear of the carts 100 together.

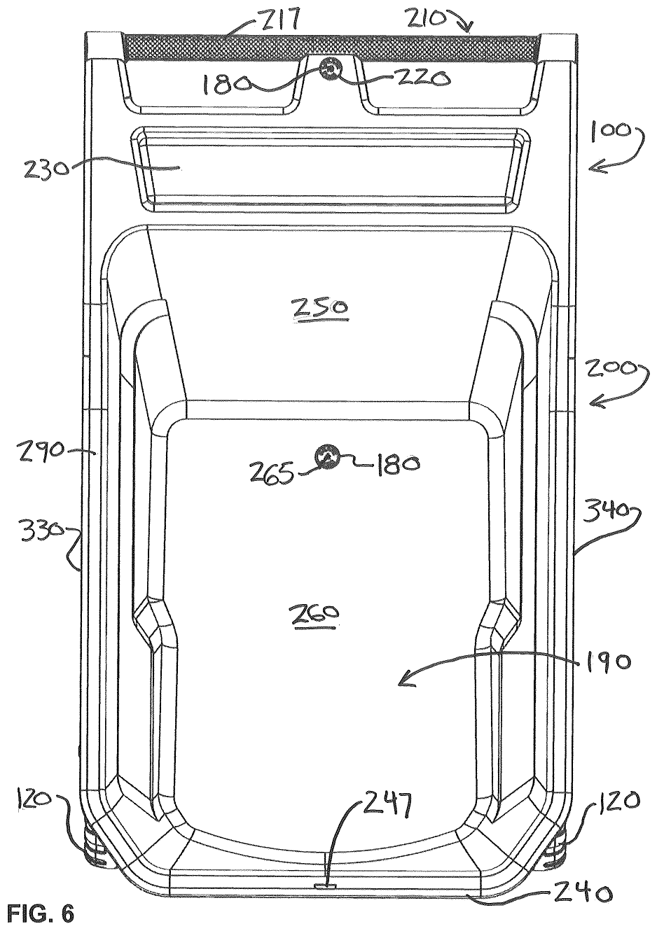

The total stack shipping strap 620 passes over the entire shipping stack of carts 600 and through forklift orifices 570 in the shipping pallet 500 and connects to itself to secure the shipping stack to the pallet 500. The front shipping straps 610 pass through adjacent forklift orifices 570 on the front of the pallet 530 and either the right side 550 or left side 560 with each end of the front shipping strap 610 preferably connected to a cart 100 via a hook 615. It is contemplated that the front shipping straps 610 can be secured by any method known in the art. It is further contemplated that additional strap slots 247 could be on the tub front wall 240 or side walls 330, 340 to allow the front sub stack straps 640 to secure the carts 100 together. Another aspect of the design that allows for maximizing the number of carts in a given shipping or storage volume is the location and size of the tub legs 270 and tub axle supports 280 in combination with the size of the wheels 120. As best seen in FIGS. 23 & 25-28, the wheels 120 are sized to fit and lay flat inside on the bottom 260 of the tub 200 between the front wall 240 and rear wall 250. Another feature that allows for the storage of the wheels 120 flat on the cart bottom is the curvature of front wall 240 where it meets the cart bottom 260 (see FIGS. 6 & 13). Note that the front wall 240 is convex at the junction with the cart bottom 260 as well as there is a radius between the intersection of the front wall 240 and cart bottom 260 that is sized to fit the profile of the wheels 120. To further accommodate storage of the wheels 120 within the tub bottom 260 and allowing stacking of carts 100, the wheel diameter 127 is sized to fit between the axle support separation 310 and the leg separation 320. Preferably, the axle support separation 310 is the same as the axle support separation 320.

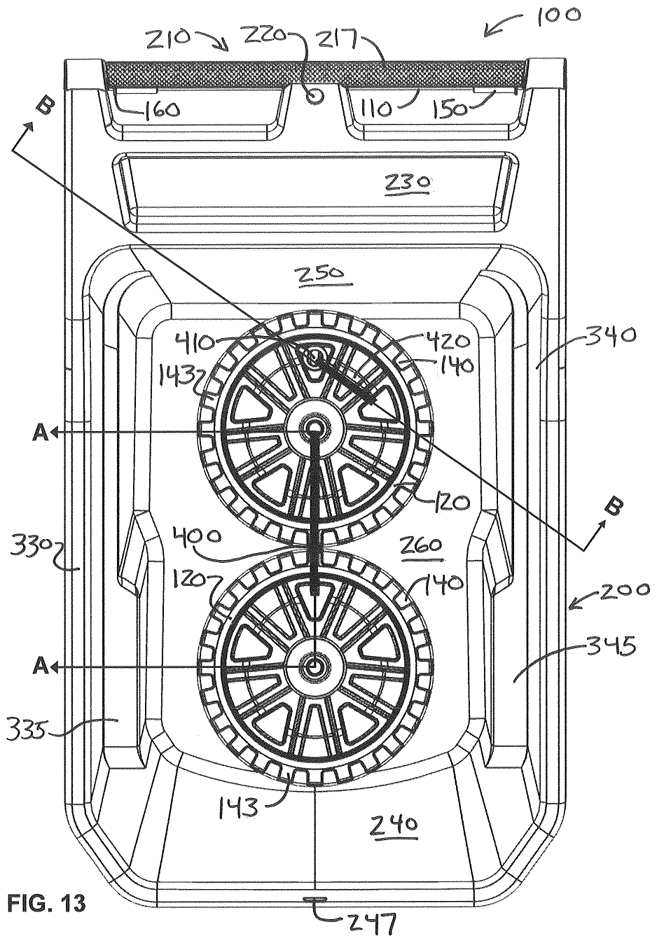

Another aspect of the present invention that allows for improved shipping and storage of the stackable utility cart 100 is the design of the wheel 120. In the preferred embodiment, each wheel 120 comprises a tire 140 and a rim 130 that is connectable to an axle 110 with a wheel diameter 127 of 12 inches. It is desirable that the tires 140 of the cart 100 have a “reverse tread” design so the tire tread 143 has a curvature to fit the profile along the tub front wall 240 when stored flat in the tub bottom 260 and to allow a wheel strap 400 to lie within the profile of the tire tread 143 (See FIGS. 13 & 15) (i.e., the wheel strap thickness 405 is less than the tire tread profile depth). Each wheel 120 is preferably secured to the axle 110 via a pin 170, preferably a lynch pin, that passes through the entire diameter of the axle and locks in place to avoid in advertent removal of the pin 170. Washers 160 are preferably placed between the wheel rim 130 and pin 170 to reduce friction that would be caused by the pin 170 being in direct contact with the wheel rim 130.

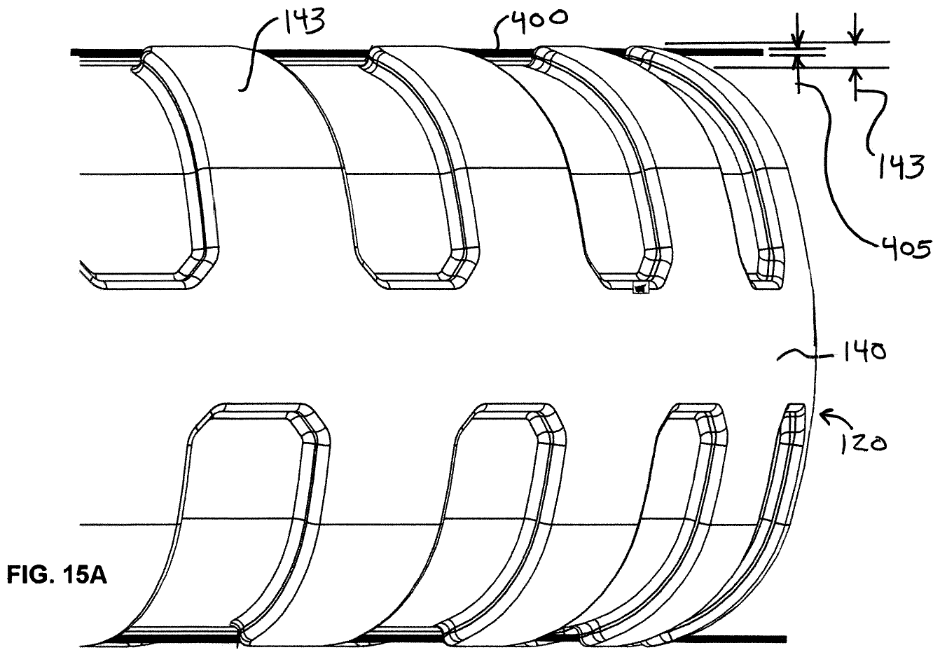

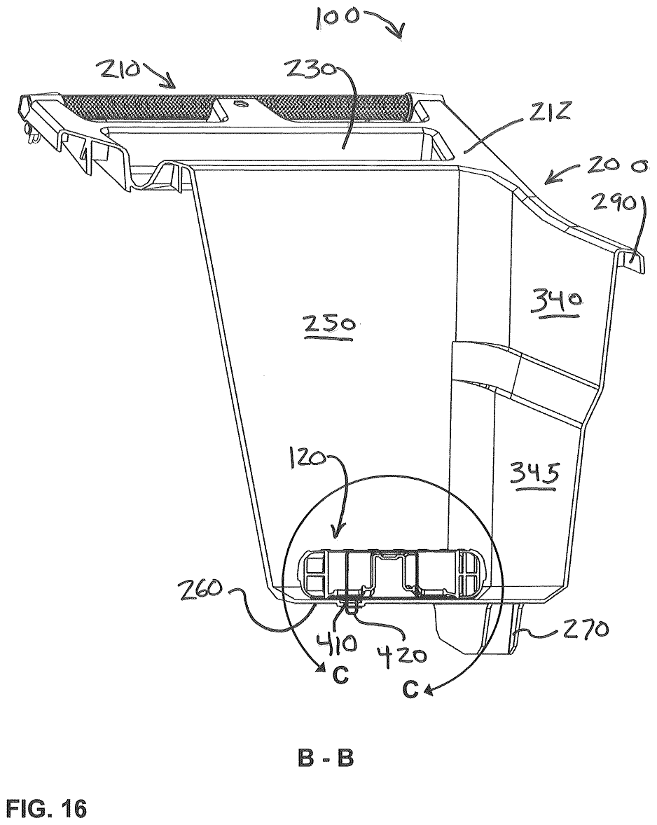

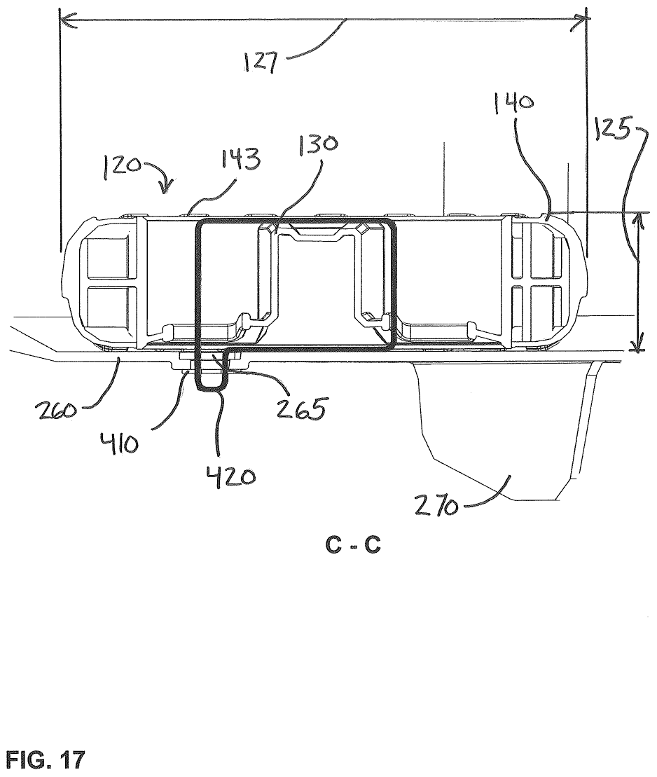

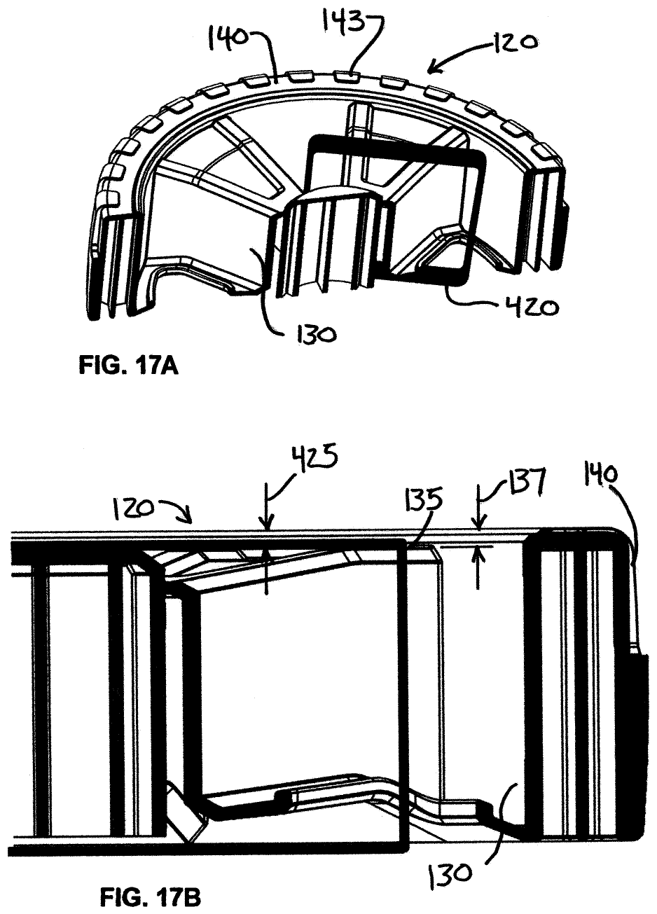

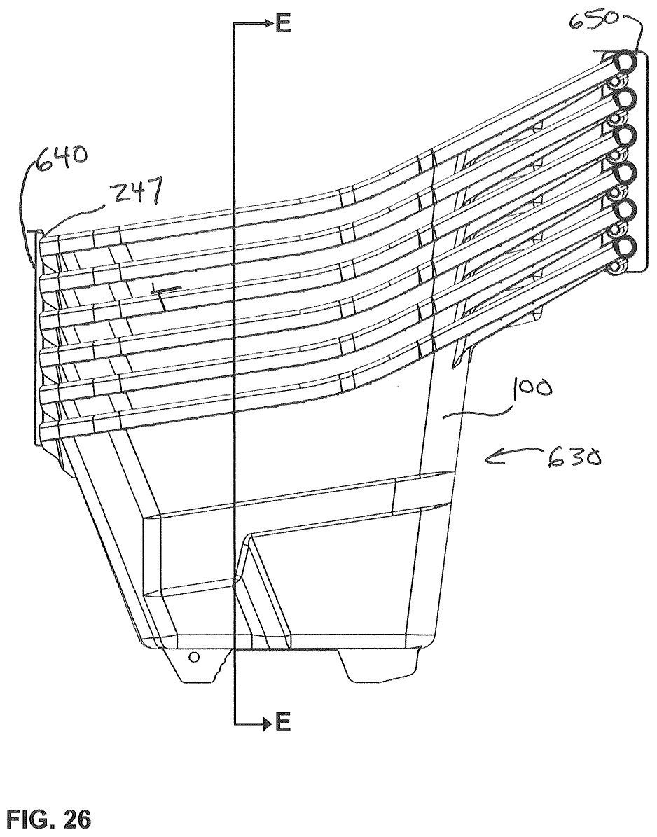

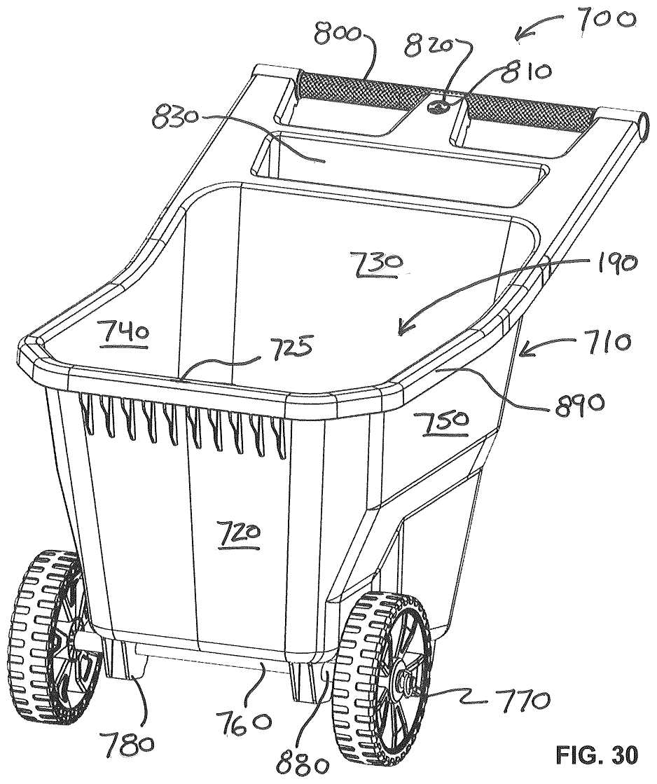

Referring to FIGS. 16-17, another aspect of the wheel 120 design that allows for improved shipping and storage of the stackable utility cart 100 is the design of the rims 130. The rims 130 have an indent 135 that allows a wheel packing strap 420 to wrap around one of the rims 130, through the drain orifice 265 and be attached to the tub 200 via a packing disk 410. As best seen in FIG. 17b, the wheel rim 130 has an indent 135 with a rim indent depth 137. The rim indent depth 137 is greater than the wheel strap thickness 405. The wheel strap 400 and wheel packing strap 420 are preferably nylon cable ties of approximately 1.3 mm thickness and 4.8 mm width but can be of any material of suitable strength to hold the wheels 120 together and keep them attached to the tub 200 during transport. The rims 130 and tires 140 of the wheels 120 are an improvement over prior art carts in that they are solid on the inside and outside, providing strength and durability over existing wheels that are not completely enclosed. While one preferred embodiment has wheels 120 constructed of separate rims 130 and tires 140, another preferred embodiment, illustrated by FIGS. 30-26 has wheel 770 that is a single piece.

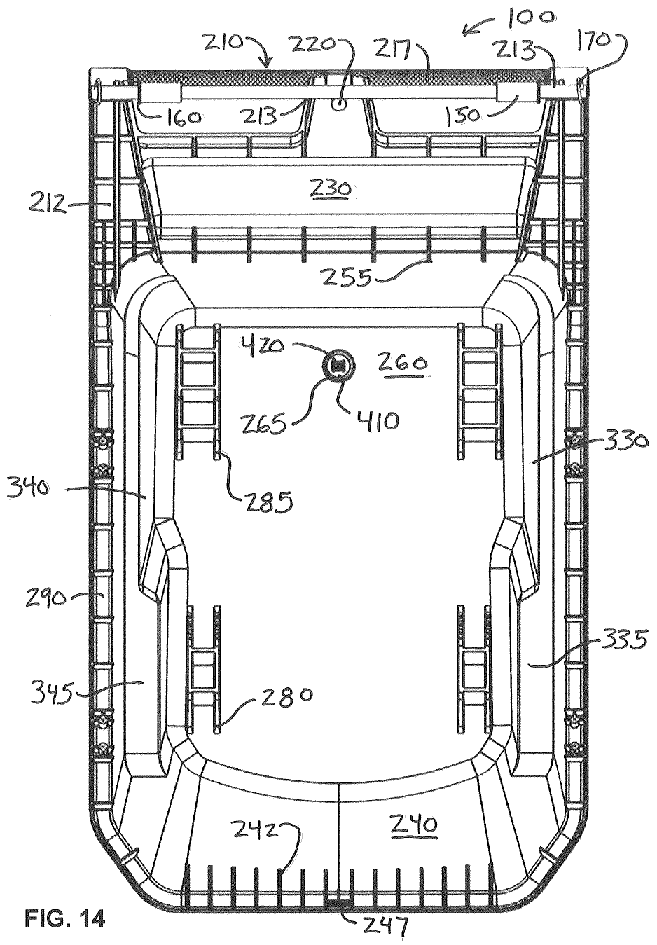

To further allow the stacking of the stackable utility cart 100 into a shipping stack 600, the axle 110 can be stored beneath the cart handle 210 by fitting into one or more axle storage notches 213 that are sized to hold the axle 110 without interfering with the stackability of the carts 100. To secure the axle 110 under the handle 210 for shipping, cable ties or similar device can be run through the lynch pins 170 and around each end of the handle 210. As can best be seen in FIG. 14, the notches 213 in the underside of the handle 210 are sized and spaced to allow the spacers 150 and washers 160 to be stored on the axle 110 when the axle 110 is in the notches 213 for shipping. While the preferred embodiment utilizes cable ties to hold the axle 110 within the notches 213, the invention also contemplates dimensioning and configuring the notches 213 so that the axle 110 can snap into and held in place for storage during shipping.

To prevent the wheels 120 from rubbing against the tub right wall 330 or tub left wall 340 when assembled and in use, a spacer 150 is located between the wheel 120 and the axle support 280. The axle 110 preferably has axle caps 115 on each end to prevent foreign material from getting inside the axle 110. The preferred embodiment has an axle width 117 (including axle caps 115) that does not exceed the tub width 205 to prevent the cart axle 110 or wheels 120 from catching on vegetation, furniture, or structures when the cart 100 is in use. The preferred embodiment also contemplates a right wall wheel well 335 and a left wall wheel well 345 to maximize the capacity of the cart 100 while allowing the wheels 120 to fit within the footprint of the cart tub 200. This design also allows for more stability when carrying a load while having the wheels 120 within the tub 200 footprint by having the axle supports 280 located toward at the out edges against the innermost walls of the right and left wall wheel wells, 335, 345.

The above improvements for the stackable utility cart 100 of the present invention are achieved while maximizing the number of carts 100 that can be stacked in a given shipping or storage volume while minimizing packing waste materials. One aspect of the design that allows for improved user performance and shipping/storage is the design of the leg 270. The leg 270 has a bottom 271, the leg bottom 271 having a front portion 272 and a rear portion 273. The front portion 272 and the rear portion 273 form a leg bottom angle 274. The axle support 280 has an axle support bottom 282. The preferred embodiment of the present invention has a leg bottom front portion 272 and axle support bottom 282 that are parallel to the tub bottom 260. The preferred embodiment further contemplates the leg 270 having a leg height 275 being the distance between the leg bottom front portion 272 and tub bottom 260 and the axle support 280 having an axle support height 287 being the distance between the axle support bottom 282 and tub bottom 260, with the leg height 275 and axle support height 287 being equal. This configuration allows the tub bottom 260 to parallel the surface upon which the tub (i.e., unassembled cart 100) rests. The preferred embodiment contemplates the leg height 275 and axle support height 287 to be slightly longer than the wheel width 125 so that the bottom 260 of a cart 100 stacked within another cart 100 does not place any weight on the wheels 120 stored within the lower cart 100.

Referring to FIGS. 30-36, a further embodiment of the stackable utility cart 700 is depicted in accordance with an embodiment of the disclosure. The stackable utility cart 700 is configured to allow the stacking in the same manner as the embodiment of FIGS. 1-7 with a lesser interior volume 190.

The stackable utility cart 700 includes a tub 710, a plurality of wheels 770, and an axle 760. The tub 710 includes a front wall 720, rear wall 730, bottom 840, right wall 740, left wall 750, and lip 890. The tub 710 further includes a handle 800, one or more legs 790, and one or more axle supports 780. The tub 710, wheels 770, legs 790, and axle supports 780 are dimensioned to allow the lip 890 to be generally parallel to a surface upon which the cart 700 rests. The tub 710, legs 790, and axle supports 780 are dimensioned so that when the wheels 770 are not installed, the bottom 840 is parallel to the surface upon which the cart 700. The legs 790 and axle supports 780 may be solid, enclosed yet partially hollow, or as shown in the drawings, molded with walls and spaces to decrease the weight of the cart 700 while still meeting structural requirements. This design allows for optimum load handling when the cart 700 is in use and allows unassembled carts 100 to be stacked for efficient shipping and storage.

The tub 710 also preferably includes a tray 830 for storage of tools or other paraphernalia and is preferably between the handle 800 and rear wall 730 to allow ease of access. It is desirable that the tray 830 be as deep as possible without interfering with the ability to stack the utility cart 700 to maximize volume. The tub 700 may also include a drain orifice 860 that is optimally located at the lowest part of the tub 710 to allow liquids to be drained from the cart 700 or for the cart 700 to be washed without having to tip it over to drain. To prevent material from inadvertently draining from the tub 740, the cart 700 includes a removable drain plug 820. The drain plug 820 may be stored in a plug storage cavity 810 located anywhere on the tub 710, but preferably located near the handle 800 for ease of access and to see if it is installed. The plug storage cavity 810 is also used to store the drain plug 820 when the cart 700 is in its shipping or storage configuration.

The stackable utility cart 700 of the embodiment illustrated in FIGS. 30-36 includes additional elements as that of the embodiment illustrated in FIGS. 1-7 such as the right wheel well 745, left wheel well 755, packing disk 870, and axle storage notch 785 to allow multiple carts 700 to be similarly stacked for increased shipping and storage density. Due to the smaller volume of this embodiment, the handle offset 850 is much longer than that of the larger embodiment to allow for user comfort.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Further incorporated into this disclosure in the information contained in the Appendix to the Specification, filed with the present specification.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

We claim:

1. A stackable cart comprising:
a tub comprising a front wall, a rear wall, a bottom, a right wall, a left wall, and an interior volume;
a handle;
a pair of legs, each leg having a leg bottom front portion and a leg bottom rear portion;
a pair of axle supports, each axle support having an axle support bottom;
an axle;
a pair of wheels rotatably connectable to the tub; and
a handle operably connected to the tub;
wherein the interior volume is configured to receive the pair of wheels and a tub of a second stackable cart within the interior volume when the second stackable cart is nested within the stackable cart; and
wherein the second stackable cart comprises:
a pair of legs, each leg having a leg bottom front portion and a leg bottom rear portion;
a pair of axle supports, each axle support having an axle support bottom; and
wherein the second stackable cart leg bottom front portions and axle support bottoms rest on the stackable cart tub bottom when the second stackable cart is nested within the stackable cart.

2. The stackable cart of claim 1 wherein the tub bottom is parallel to the axle support bottoms and the leg bottom front portions.

3. The stackable cart of claim 1 wherein when the axle is operably connected to the axle supports, the wheels are operably connected to the axle, and the cart rests on the wheels and the leg bottom rear portions and when the wheels are not operably connected to the axle, the cart rests on the leg bottom front portion and the axle support bottom.

4. The stackable cart of claim 3 wherein the leg bottom rear portion and the axle support bottom are parallel to the tub bottom.

5. The stackable cart of claim 3 wherein the cart bottom slopes from the front wall to the rear wall.

6. The stackable cart of claim 5 wherein the front wall is generally perpendicular to a surface upon which the cart rests.

7. The stackable cart of claim 3 further comprising a tub lip proximate the top of the right wall, left wall, and front wall wherein the stackable cart wheels do not protrude beyond the tub lip.

8. The stackable cart of claim 7 wherein the front wall, left wall, and front wall are connected to the tub lip via ribs.

9. The stackable cart of claim 8 wherein the ribs connecting the front wall to the lip is two-tiered.

10. The stackable cart of claim 8 further comprising a strap slop in the lip of the front wall.

11. The stackable cart of claim 1 further comprising a leg separation, an axle support separation, and a wheel diameter wherein the leg separation and axle support separation are greater than the wheel diameter.

12. The stackable cart of claim 11 wherein one of the stackable cart wheels rests on the stackable tub bottom between the second stackable carts legs and the other stackable cart wheel rests on the stackable tub bottom between the between the second stackable cart axle supports.

13. The stackable cart of claim 1 further comprising a drain orifice in the tub bottom, a packing disk, and wheel packing strap wherein the packing disk and wheel packing strap secure one of wheels to the tub bottom through the drain orifice.

14. The stackable cart of claim 13 further comprising a wheel strap wherein the wheel strap secures the two wheels together.

15. The stackable cart of claim 13 wherein the wheels are secured between the second stackable cart legs and axle supports when the second stackable cart is nested within the stackable cart.

16. A stackable cart comprising:
a tub comprising a front wall, a rear wall, a bottom, a right wall, a left wall, and an interior volume;
a handle;
a pair of legs, each leg having a leg bottom front portion and a leg bottom rear portion;
a pair of axle supports, each axle support having an axle support bottom;
an axle;
a pair of wheels rotatably connectable to the tub;
a handle operably connected to the tub;
a drain orifice in the tub bottom;
a packing disk;
a wheel packing strap; and
a wheel strap;
wherein the wheel strap secures the two wheels together and the wheel packing strap and packing disk secure at least one wheel to the tub bottom through the drain orifice.

17. The stackable cart of claim 16 wherein the tub bottom is parallel to the axle support bottoms and the leg bottom front portions.

18. The stackable cart of claim 17 wherein each of the pair of wheels comprises a wheel width and each of the pair of legs comprises a leg height wherein the wheel width is less than the leg height.

19. The stackable cart of claim 18 wherein each of the pair of axle supports comprises an axle support height wherein the wheel width is less than the axle support height.

20. A stackable cart comprising:
a tub comprising a front wall, a rear wall, a bottom, a right wall, a left wall, and an interior volume;
a handle;
a pair of legs, each leg having a leg bottom front portion and a leg bottom rear portion;
a pair of axle supports, each axle support having an axle support bottom;
an axle;
a pair of wheels rotatably connectable to the tub;
a handle operably connected to the tub;
a drain orifice in the tub bottom;
a packing disk;
a wheel packing strap; and
a wheel strap;
wherein the wheel strap secures the two wheels together and the wheel packing strap and packing disk secure at least one wheel to the tub bottom through the drain orifice; and
wherein when the axle is operably connected to the axle supports, the wheels are operably connected to the axle, and the cart rests on the wheels and the leg bottom rear portions and when the wheels are not operably connected to the axle, the cart rests on the leg bottom front portion and the axle support bottom.
